(19) United States
(12) Patent Application Publication
(10) Pub. No.: US 2025/0320382 A1
(43) Pub. Date: Oct. 16, 2025

(54) RESIN COMPOSITION, METHOD FOR MANUFACTURING DISPLAY DEVICE, AND THE DISPLAY DEVICE

(71) Applicant: Samsung Display Co., Ltd., Yongin-si (KR)

(72) Inventor: Keisuke MORITA, Yokohama (JP)

(21) Appl. No.: 19/023,015

(22) Filed: Jan. 15, 2025

(30) Foreign Application Priority Data
Apr. 12, 2024 (KR) 10-2024-0049083

(51) Int. Cl. C09J 4/06; C09J 5/00; C09J 11/08; C09J 133/06

(52) U.S. Cl. CPC C09J 4/06; C09J 5/00; C09J 11/08; C09J 133/066

(57) ABSTRACT

A resin composition includes at least one urethane (meth)acrylate having a weight-average molecular weight of about 5,000 to about 50,000, at least one monofunctional (meth)acrylate monomer, at least one photoinitiator including a radical polymerization initiator, and a polyether-modified dimethylsiloxane having a number-average molecular about 1,000 to about 30,000, and excludes any polyfunctional (meth)acrylate monomer. The resin composition has a viscosity of about 5 mPa·s to about 20 mPa·s as measured at about 25° C. by the JIS K7117-2 method. Based on 100% of a total molecular weight of the polyether-modified dimethylsiloxane, a molecular weight of the dimethylsiloxane group may be about 15% to about 90%. When the sum of a weight of the urethane (meth)acrylate and a weight of the monofunctional (meth)acrylate monomer is 100 parts by weight, a weight of the polyether-modified dimethylsiloxane may be about 0.001 parts by weight to about 0.1 parts by weight.

### CROSS-REFERENCE TO RELATED APPLICATION

The present application claims priority to and benefit of Korean Patent Application No. 10-2024-0049083, filed on Apr. 12, 2024, in the Korean Intellectual Property Office, the entire disclosure of which is incorporated herein by reference.

### BACKGROUND

One or more embodiments of the present disclosure relate to a resin composition a method for manufacturing a display device, and the display device. The method includes providing the resin composition to form an adhesive member, and the display device includes the adhesive member formed from the resin composition.

Various display devices used in multimedia devices such as television sets, mobile phones, tablet computers, navigation units, and/or game consoles, are being developed and continuously improved. For example, recently, there has been signification progress in developing foldable, bendable, and/or rollable display devices using flexible display members (that are bendable) to facilitate portability and/or to increase user friendliness. Therefore, an adhesive resin used to form an adhesive layer applied to one or more suitable forms (e.g., shapes) of display devices should need to have excellent or suitable coating properties suitable for different components or forms of these display devices. In other words, the adhesive resin used to form an adhesive layer for different forms/shapes and/or types of display devices needs to have excellent coating properties suitable for various components of these devices.

### SUMMARY

One or more aspects of embodiments of the present disclosure are directed toward a resin composition that exhibits excellent or suitable applicability on one or more suitable members (e.g., different parts or components of display devices), a method for manufacturing a display device, the method including providing the resin composition to form an adhesive member, and the display device including the adhesive member formed from the resin composition.

Additional aspects will be set forth in part in the description which follows and, in part, will be apparent from the description, or may be learned by practice of the presented embodiments.

According to one or more embodiments of the present disclosure, a resin composition includes: at least one urethane (meth)acrylate having a weight-average molecular weight of about 5,000 to about 50,000; at least one monofunctional (meth)acrylate monomer; at least one photoinitiator including a radical polymerization initiator; and a polyether-modified dimethylsiloxane having a number-average molecular weight of about 1,000 to about 30,000 and including a polyether group and a dimethylsiloxane group, wherein a (any) polyfunctional (meth)acrylate monomer is not included, a viscosity of the resin composition, measured at about 25° C. by the JIS K7117-2 method, is in a range of about 5 mPa·s to about 20 mPa·s, a molecular weight of the dimethylsiloxane group is in a range of about 15% to about 90% based on 100% of the total molecular weight (i.e., the number-average molecular weight) of the polyether-modified dimethylsiloxane, and if (e.g., when) the sum of a weight of the urethane (meth)acrylate and a weight of the monofunctional (meth)acrylate monomer is 100 parts by weight, a weight of the polyether-modified dimethylsiloxane is in a range of about 0.001 parts by weight to about 0.1 parts by weight.

In one or more embodiments, the resin composition may satisfy Expression 1:

$$1. \leq {D}_{L} \leq 1.2 . \qquad Expression 1$$

In Expression 1, D_{L} is a ratio of a second diameter to a first diameter, the first diameter is a diameter of a droplet measured 1 second after providing the resin composition on a member according to the JIS R 3257 method, and the second diameter is a diameter of the droplet measured 60 seconds after providing the resin composition on the member.

In one or more embodiments, the monofunctional (meth)acrylate monomer may include at least one of 4-hydroxybutyl acrylate (4-HBA) or 2-ethylhexyl acrylate (2-EHA).

In one or more embodiments, the weight of the monofunctional (meth)acrylate monomer may be in a range of about 87 wt % to about 93 wt % based on the sum 100 wt % of the weight of the urethane (meth)acrylate and the weight of the monofunctional (meth)acrylate monomer.

In one or more embodiments, the radical polymerization initiator may include phenylbis(2,4,6-trimethylbenzoyl)phosphine oxide.

In one or more embodiments, the resin composition may be provided by an inkjet printing method or a dispensing method.

In one or more embodiments of the present disclosure, a method for manufacturing a display device includes: preparing a display module; providing a window on the display module; and providing an adhesive member on a first surface of the display module or a second surface of the window before the providing of the window, wherein the providing of the adhesive member includes: providing a resin composition on the first surface or the second surface, the resin composition having a viscosity of about 5 mPa·s to about 20 mPa·s as measured at about 25° C. by the JIS K7117-2 method; and providing light to the resin composition to form the adhesive member, and wherein the resin composition includes: at least one urethane (meth)acrylate having a weight-average molecular weight of about 5,000 to about 50,000; at least one monofunctional (meth)acrylate monomer; at least one photoinitiator including a radical polymerization initiator; and a polyether-modified dimethylsiloxane having a number-average molecular weight of about 1,000 to about 30,000 and including a polyether group and a dimethylsiloxane group, and does not include a (any) polyfunctional (meth)acrylate monomer, wherein a molecular weight of the dimethylsiloxane group is in a range of about 15% to about 90% based on 100% of the total molecular weight (i.e., the number-average molecular weight) of the polyether-modified dimethylsiloxane, and if (e.g., when) the sum of a weight of the urethane (meth)acrylate and a weight of the monofunctional (meth)acrylate monomer is 100 parts by weight, a weight of the polyether-modified dimethylsiloxane is in a range of about 0.001 parts by weight to about 0.1 parts by weight.

In one or more embodiments, the resin composition may be provided directly on the first surface or the second surface.

In one or more embodiments, the method for manufacturing the display device, between the providing of the adhesive member and the providing of the window, may further include: preparing a light control layer; and providing the resin composition on a third surface of the light control layer to form an optical adhesive layer.

In one or more embodiments, the resin composition may be provided directly on the third surface.

In one or more embodiments of the present disclosure, an electronic device includes: a display panel; a window arranged on the display panel; and an adhesive member arranged between the display panel and the window and including a polymer derived from a resin composition having a viscosity as measured at about 25° C. by the JIS K7117-2 method of about 5 mPa·s to about 20 mPa·s, wherein the resin composition includes: at least one urethane (meth)acrylate having a weight-average molecular weight of about 5,000 to about 50,000; at least one monofunctional (meth)acrylate monomer; at least one photoinitiator including a radical polymerization initiator; and a polyether-modified dimethylsiloxane having a number-average molecular weight of about 1,000 to about 30,000 and including a polyether group and a dimethylsiloxane group, and does not include a (any) polyfunctional (meth)acrylate monomer, wherein a molecular weight of the dimethylsiloxane group is in a range of about 15% to about 90% based on 100% of the total molecular weight (i.e., the number-average molecular weight) of the polyether-modified dimethylsiloxane, and if (e.g., when) the sum of a weight of the urethane (meth)acrylate and a weight of the monofunctional (meth)acrylate monomer is 100 parts by weight, a weight of the polyether-modified dimethylsiloxane is in a range of about 0.001 parts by weight to about 0.1 parts by weight.

In one or more embodiments, the adhesive member may be optically clear.

In one or more embodiments, the electronic device may further include a light control layer arranged between the adhesive member and the window and an optical adhesive layer arranged between the light control layer and the window, and the optical adhesive layer may include the polymer derived from the resin composition.

In one or more embodiments, the light control layer may include a polarization plate and/or a color filter layer.

In one or more embodiments, the display panel may be foldable with respect to at least one folding axis.

In one or more embodiments, the electronic device may further include an input sensing unit arranged between the display panel and the window, and the adhesive member may be arranged between the display panel and the input sensing unit or between the input sensing unit and the window.

### BRIEF DESCRIPTION OF DRAWINGS

The accompanying drawings are included to provide a further understanding of the disclosure, and are incorporated in and constitute a part of this disclosure. The drawings illustrate example embodiments of the present disclosure and, together with the description, serve to explain principles of the disclosure. Above and/or other aspects of the present disclosure should become apparent and appreciated from the following description of embodiments taken in conjunction with the accompanying drawings. In the drawings:

FIG. 1A is a perspective view illustrating a display device of one or more embodiments of the disclosure;

FIG. 1B is a perspective view illustrating a display device of one or more embodiments of the disclosure;

FIG. 1C is a plan view illustrating a display device of one or more embodiments of the disclosure;

FIG. 1D is a perspective view illustrating a display device of one or more embodiments of the disclosure;

FIG. 2 is an exploded perspective view illustrating a display device of one or more embodiments of the disclosure;

FIG. 3 is a cross-sectional view illustrating a portion corresponding to the line I-I′ of FIG. 2;

FIG. 4 is a cross-sectional view illustrating a portion of a display device according to one or more embodiments of the disclosure;

FIG. 5 is a cross-sectional view illustrating a display device of one or more embodiments of the disclosure;

FIG. 6 is a cross-sectional view illustrating a display device of one or more embodiments of the disclosure;

FIG. 7 is a flowchart showing a method for manufacturing a display device of one or more embodiments of the disclosure;

FIG. 8A is a view schematically illustrating a method for manufacturing a display device of one or more embodiments of the disclosure;

FIG. 8B is a view schematically illustrating a method for manufacturing a display device of one or more embodiments of the disclosure;

FIG. 8C is a view schematically illustrating a method for manufacturing a display device of one or more embodiments of the disclosure;

FIG. 8D is a view schematically illustrating a method for manufacturing a display device of one or more embodiments of the disclosure;

FIG. 9A is a view schematically illustrating a method for manufacturing a display device of one or more embodiments of the disclosure;

FIG. 9B is a view schematically illustrating a method for manufacturing a display device of one or more embodiments of the disclosure;

FIG. 9C is a view schematically illustrating a method for manufacturing a display device of one or more embodiments of the disclosure;

FIG. 10A is a view schematically illustrating a method for manufacturing a display device of one or more embodiments of the disclosure;

FIG. 10B is a view schematically illustrating a method for manufacturing a display device of one or more embodiments of the disclosure;

FIG. 10C is a view schematically illustrating a method for manufacturing a display device of one or more embodiments of the disclosure;

FIG. 11A is a view schematically illustrating a method for manufacturing a display device of one or more embodiments of the disclosure;

FIG. 11B is a view schematically illustrating a method for manufacturing a display device of one or more embodiments of the disclosure;

FIG. 11C is a view schematically illustrating a method for manufacturing a display device of one or more embodiments of the disclosure;

FIG. 12A is a view schematically illustrating a droplet formed by providing the resin composition of Example of the disclosure; and

FIG. 12B is a view schematically illustrating a droplet formed by providing the resin composition of Comparative Example of the disclosure.

### DETAILED DESCRIPTION

Embodiments of the present disclosure may be modified and practiced in many alternate forms, and thus example embodiments will be exemplified in the drawings and described in more detail in the detailed description. It should be understood, however, that it is not intended to limit the disclosure to the particular forms disclosed, but rather, is intended to cover all modifications, equivalents, and alternatives falling within the spirit and scope of the disclosure.

In the present disclosure, if (e.g., when) a component (or a region, a layer, a portion, and/or the like) is referred to as being “on,” “connected to,” or “coupled to” another component, it refers to that the component may be directly arranged on/connected to/coupled to the other component, or that a third component may be arranged therebetween. In contrast, when an element is referred to as being “directly on,” “directly connected to,” or “directly coupled to” another element, there are no intervening elements present therebetween.

In the present disclosure, like reference numerals refer to like components throughout. Also, in the drawings, the thicknesses, the ratios, and the dimensions of components may be exaggerated for effective description of technical contents. The term “and/or” or “or” may include all combinations of one or more of which associated configurations may define.

It will be understood that, although the terms “first,” “second,” and/or the like may be used herein to describe one or more suitable components, these components should not be limited by these terms. These terms are only used to distinguish one component from another. For example, a first component could be termed a second component, and, similarly, a second component could be termed a first component, without departing from the scope of the disclosure. As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure.”

In addition, terms such as “below,” “under,” “on,” and “above” may be used to describe the relationship between components illustrated in the drawings. The terms are used as a relative concept and are described with reference to the direction indicated in the drawings.

It should be understood that the term “comprise(s)/comprising,” “include(s)/including,” or “have(has)/having” is intended to specify the presence of stated features, integers, steps, operations, components, parts, and/or one or more (e.g., any suitable) combinations thereof in the disclosure, but does not preclude the presence or addition of one or more other features, integers, steps, operations, components, parts, and/or one or more (e.g., any suitable) combinations thereof.

Unless otherwise defined, all terms (including technical and scientific terms) used herein have the same meaning as commonly understood by one of ordinary skill in the art to which the disclosure belongs. In addition, it will be understood that terms, such as those defined in commonly used dictionaries, should be interpreted as having a meaning that is consistent with their meaning in the context of the relevant art and will not be interpreted in an idealized or overly formal sense unless expressly so defined herein.

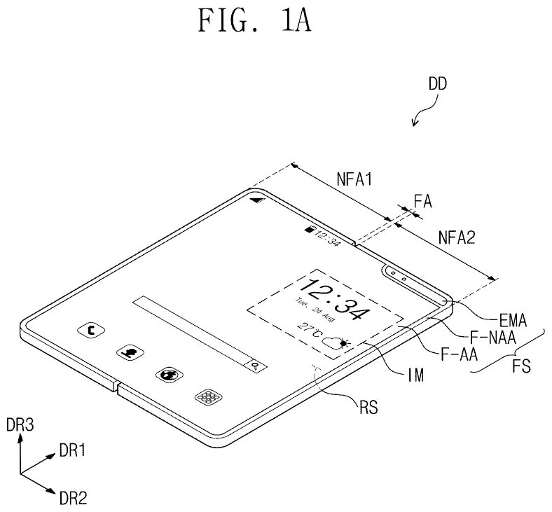

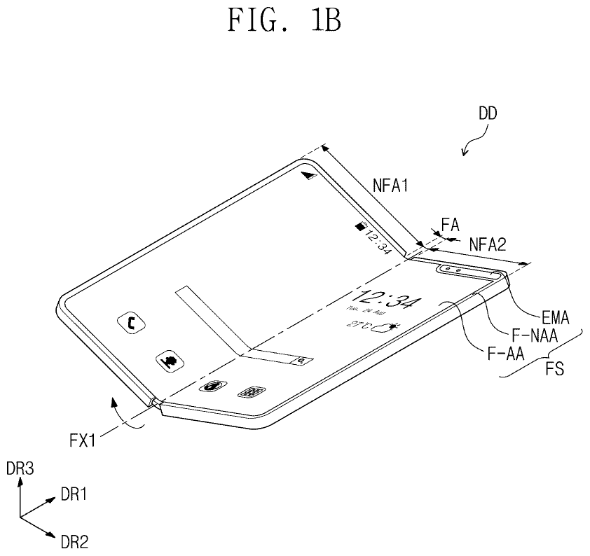

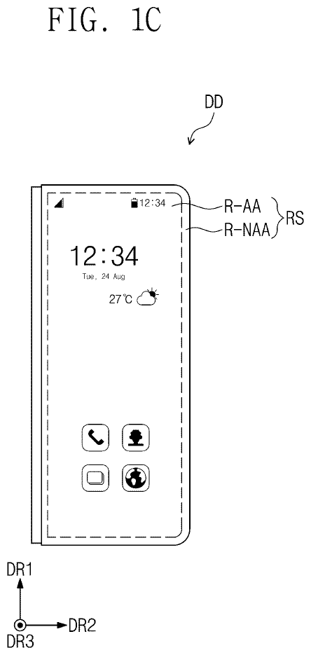

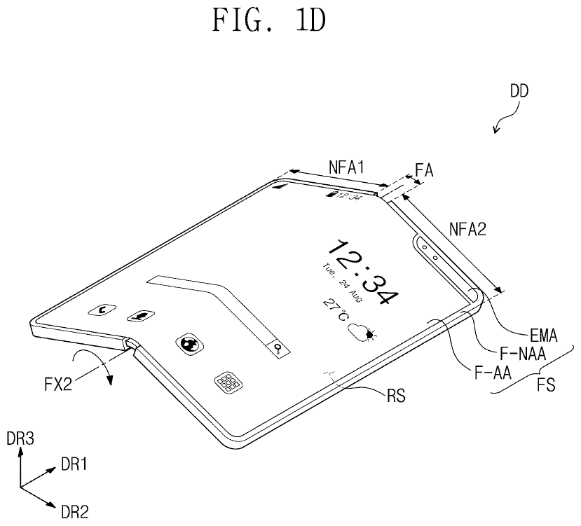

Hereinafter, an adhesive member according to one or more embodiments of the present disclosure and a display device including the adhesive member will be described in more detail with reference to the accompanying drawings. FIG. 1A is a perspective view of a display device DD in an unfolded state according to one or more embodiments of the present disclosure.

In one or more embodiments, the display device DD may be a device that is activated according to an electrical signal. For example, in one or more embodiments, the display device DD may be a mobile phone, a tablet, a car navigation device, a game console, or a wearable device, but embodiments of the present disclosure are not limited thereto. FIG. 1A, as an example, illustrates that the display device DD is a mobile phone. In this specification, an electronic device may be the display device DD or may include the display device DD.

In one or more embodiments, the display device DD may include a first display surface FS defined by a first direction axis DR1 and a second direction axis DR2 crossing (e.g., intersecting) the first direction axis DR1. The display device DD may provide an image IM to a user through the first display surface FS. The display device DD may display the image IM towards the direction of a third direction axis DR3 on the first display surface FS parallel to each of the first direction axis DR1 and the second direction axis DR2.

In the present disclosure, the first direction axis DR1 and the second direction axis DR2 are orthogonal to each other, and the third direction axis DR3 may be a normal direction with respect to a plane defined by the first direction axis DR1 and the second direction axis DR2. A thickness direction of the display device DD may be a direction parallel to the third direction axis DR3. A front (front-facing) surface (or top surface) and a rear (rear-facing) surface (or bottom surface) may be opposite to each other in the third direction axis DR3, and the normal direction to each of the front surface and the rear surface may be parallel to the third direction axis DR3. The front surface (or top surface) refers to a surface adjacent to the first display surface FS and the rear surface (or bottom surface) refers to a surface spaced and/or apart (e.g., spaced apart or separated) from the first display surface FS. In one or more embodiments, the rear surface (or bottom surface) may refer to a surface close to a second display surface RS which will be described in more detail later. The term “top” refers to a direction closer to the first display surface FS, and the term “bottom” refers to a direction away from the first display surface FS. In other words, the front (or top) surface is near or close to the first display surface FS, while the rear (or bottom) surface is further away the first display surface FS (e.g., close to the second display surface RS).

A cross-section (cross-section view) refers to (a view toward) a surface parallel to the thickness direction DR3 (i.e., third direction axis DR3), and a plane (plan view) refers to (a view toward) a surface normal (e.g., perpendicular) to the thickness direction DR3. For example, the plane refers to a plane defined by the first direction axis DR1 and the second direction axis DR2.

The directions indicated by the first to third direction axes DR1, DR2, and DR3 as described in the disclosure are relative concepts, and may thus be changed to other directions. In addition, the directions indicated by the first to third direction axes DR1, DR2, and DR3 may be described as first to third directions, respectively, and the same reference symbols may be used.

The display device DD may detect external inputs applied from the outside. The external inputs may include one or more suitable forms/types of inputs provided from the outside of the display device DD. For example, in one or more embodiments, the external inputs may include external inputs applied when approaching the display device DD or being adjacent at a preset distance (e.g., hovering) by a part of a body, as well as contact by a part of the body such as a user's hand. In addition, the external inputs may have one or more other suitable forms such as force, pressure, temperature, and light.

In one or more embodiments, the display device DD may include the first display surface FS and the second display surface RS. The first display surface FS may include a first active region F-AA, a first peripheral region F-NAA, and an electronic module region EMA. The second display surface RS may be defined as a surface opposite to (e.g., facing) at least a part of the first display surface FS. For example, the second display surface RS may be defined as a part of a rear surface of the display device DD.

The first active region F-AA may be a region activated according to electrical signals. In one or more embodiments, the first active region F-AA may be a region displaying the image IM and sensing external inputs of one or more suitable forms.

The first peripheral region F-NAA may be adjacent to the first active region F-AA. The first peripheral region F-NAA may have a set or predetermined color. The first peripheral region F-NAA may be around (e.g., surround) the first active region F-AA. Accordingly, the shape of the first active region F-AA may be substantially defined by the first peripheral region F-NAA. However, this is illustrated as an example, and the first peripheral region F-NAA may be arranged adjacent to only one side of the first active region F-AA, or may not be provided.

The electronic module region EMA may have one or more suitable electronic modules arranged therein. For example, in one or more embodiments, the electronic module may include at least one selected from among a camera, a speaker, a light detection sensor, and a heat detection sensor. The electronic module region EMA may detect an external subject by receiving a signal through the display surfaces FS and/or RS, or provide sound signals such as voice to the outside through the display surfaces FS and/or RS. The electronic module may include a plurality of components, and embodiments of the present disclosure are not limited thereto.

In one or more embodiments, the electronic module region EMA may be surrounded by the first peripheral region F-NAA. However, this is merely an example, and embodiments of the disclosure are not limited thereto. For example, in one or more embodiments, the electronic module region EMA may be surrounded by the first active region F-AA and the first peripheral region F-NAA, and the electronic module region EMA may be arranged in the first active region F-AA.

In one or more embodiments, the display device DD may be a flexible display device. The display device DD of one or more embodiments may include a (e.g., at least one) folding region FA and two or more (e.g., a plurality of) non-folding regions NFA1 and NFA2 extending from the folding region FA. For example, a first non-folding region NFA1, the folding region FA, and a second non-folding region NFA2 may be defined in the second direction DR2. In other words, along the second direction DR2, the display device includes the first non-folding region NFA1, the folding region FA, and the second non-folding region NFA2. In one or more embodiments, the display device DD may include the first non-folding region NFA1 and the second non-folding region NFA2 that are spaced and/or apart (e.g., spaced apart or separated) from each other in the second direction DR2 with the folding region FA located therebetween. For example, in one or more embodiments, the first non-folding region NFA1 may be arranged on one side of the folding region FA in the second direction DR2, and the second non-folding region NFA2 may be arranged on the other side of the folding region FA in the second direction DR2.

Although FIG. 1A, and/or the like, illustrates one or more embodiments of the display device DD including one folding region FA, embodiments of the present disclosure are not limited thereto, and a plurality of folding regions may be defined in the display device DD. For example, the display device according to one or more embodiments may include two or more folding regions, and may also include three or more non-folding regions arranged with each of the folding regions located therebetween.

FIG. 1B is a perspective view illustrating a folding operation of the display device DD according to one or more embodiments of the present disclosure. FIG. 1C is a plan view of the display device DD in a folded state according to one or more embodiments of the present disclosure. FIG. 1D is a perspective view illustrating a folding operation of the display device DD according to one or more embodiments of the present disclosure.

Referring to FIG. 1B, the display device DD of one or more embodiments may be folded with respect to a first folding axis FX1 extending in the first direction DR1. While the display device DD is folded, the folding region FA may have a set or predetermined curvature and radius of curvature. The display device DD may be folded with respect to the first folding axis FX1 to be transformed into an inner-folded state so that the first non-folding region NFA1 and the second non-folding region NFA2 face each other and the first display surface FS is not exposed to the outside.

Referring to FIG. 1C, in the display device DD of one or more embodiments, the second display surface RS may be viewed in an inner-folded state by a user. In this case, the second display surface RS may include a second active region R-AA that displays an image. The second active region R-AA may be a region activated according to electrical signals. The second active region R-AA may be a region displaying an image and sensing external inputs of one or more suitable forms.

A second peripheral region R-NAA may be adjacent to the second active region R-AA. The second peripheral region R-NAA may have a set or predetermined color. The second peripheral region R-NAA may be around (e.g., surround) the second active region R-AA. In one or more embodiments, in the display device DD, the second display surface RS may further include an electronic module region in which an electronic module including one or more suitable components is arranged, but embodiments of the present disclosure are not limited thereto.

Referring to FIG. 1D, the display device DD according to one or more embodiments may be folded with respect to a second folding axis FX2 extending in the first direction DR1. The display device DD may be folded with respect to the second folding axis FX2 and may be transformed into an outer-folded state so that the first display surface FS is exposed to the outside. In one or more embodiments, the display device DD may be configured such that the inner-folding operation or the outer-folding operation is repeated from an unfolding operation, but embodiments of the present disclosure are not limited thereto.

Although FIGS. 1A to 1D exemplarily illustrate folding with respect to one of a folding axis FX1 or a folding axis FX2, the number of folding axes and accordingly the number of non-folding regions are not limited thereto. For example, in one or more embodiments, the display device may be folded with respect to a plurality of folding axes, and thus may be folded such that a part of each of the first display surface FS and the second display surface RS faces each other. In addition, although the first and second folding axes FX1 and FX2 are illustrated as being parallel to a long side of the display device DD, embodiments of the present disclosure are not limited thereto, for example, in one or more embodiments, the first and second folding axes FX1 and FX2 may be parallel to a short side of the display device DD.

In the display device DD, the first non-folding region NFA1 and the second non-folding region NFA2 may be respectively defined as parts having display surfaces FS and RS each parallel to a plane defined by the first direction axis DR1 and the second direction axis DR2 in a folded state, and the folding region FA may be defined as a region between the first non-folding region NFA1 and the second non-folding region NFA2. The folding region FA may include a curved part bent so as to have a set or predetermined curvature in the folded state.

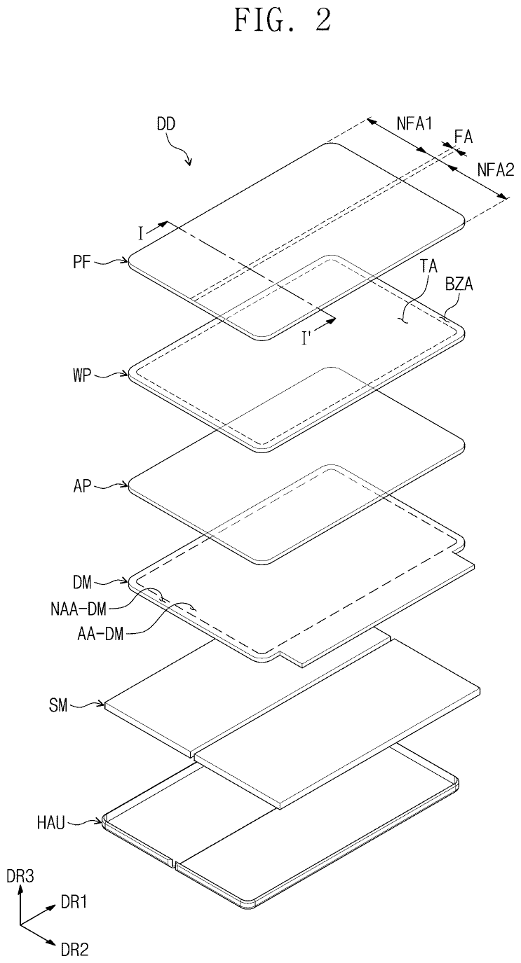

FIG. 2 is an exploded perspective view of a display device DD according to one or more embodiments of the present disclosure. Referring to FIG. 2, the display device DD according to one or more embodiments may include a display module DM, a window WP arranged on the display module DM, and an adhesive member AP arranged between the display module DM and the window WP. In addition, the display device DD may further include a support member SM arranged below (e.g., on a lower portion of) the display module DM, a protective layer PF arranged on the window WP, and a housing HAU which accommodates the display module DM, the support member SM, and/or the like.

The housing HAU may include a material having a relatively higher rigidity. For example, in one or more embodiments, the housing HAU may include a plurality of frames and/or plates formed of glass, plastic, or a metal. The housing HAU may provide a certain accommodating space. The display module may be accommodated in the accommodating space and be protected from an external impact.

The support member SM may include a metal material and/or a polymer material. For example, in one or more embodiments, the support member SM may include stainless steel, aluminum, or an alloy thereof. In one or more embodiments, the support member SM may be formed from carbon fiber reinforced plastic (CFRP) and/or the like. However, embodiments of the present disclosure are not limited thereto, and the support member SM may include a non-metal material, plastic, glass fiber reinforced plastic, or glass. In some embodiments, the support member SM may not be provided.

In one or more embodiments, the display device DD may further include a cushion layer, a shielding layer, and/or the like, arranged below (e.g., on the lower portion of) the support member SM. The cushion layer may include an elastomer such as a sponge, a foam, and/or a urethane resin. The shielding layer may be an electromagnetic wave shielding layer or a heat dissipating layer.

The display module DM may be activated in response to an electrical signal. The display module DM may be activated to display the image IM (see FIG. 1A) in the display surface FS (see FIG. 1A) of the display device DD. A display region AA-DM and a non-display region NAA-DM may be defined in the display module DM. The display region AA-DM may be a region which is activated in response to an electrical signal. The non-display region NAA-DM may be a region that is adjacent to at least one side of the display region AA-DM. A circuit or a wiring for driving the display region AA-DM may be arranged in the non-display region NAA-DM.

The adhesive member AP may be arranged on the display module DM. The display module DM and the window WP may be coupled by the adhesive member AP. The adhesive member AP may be optically clear. The term “optically clear” may refer to that the transmittance of light in the visible wavelength region is about 80% or more. For example, the adhesive member AP may have a transmittance of about 80% or more, about 85% or more, or about 90% or more for light in a wavelength region of about 400 nm to about 800 nm. The display device DD of one or more embodiments including the optically clear adhesive member AP may exhibit excellent or suitable display quality.

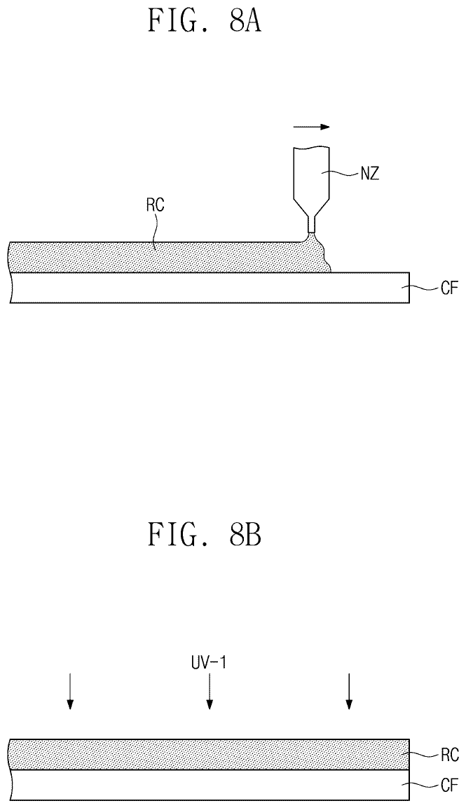

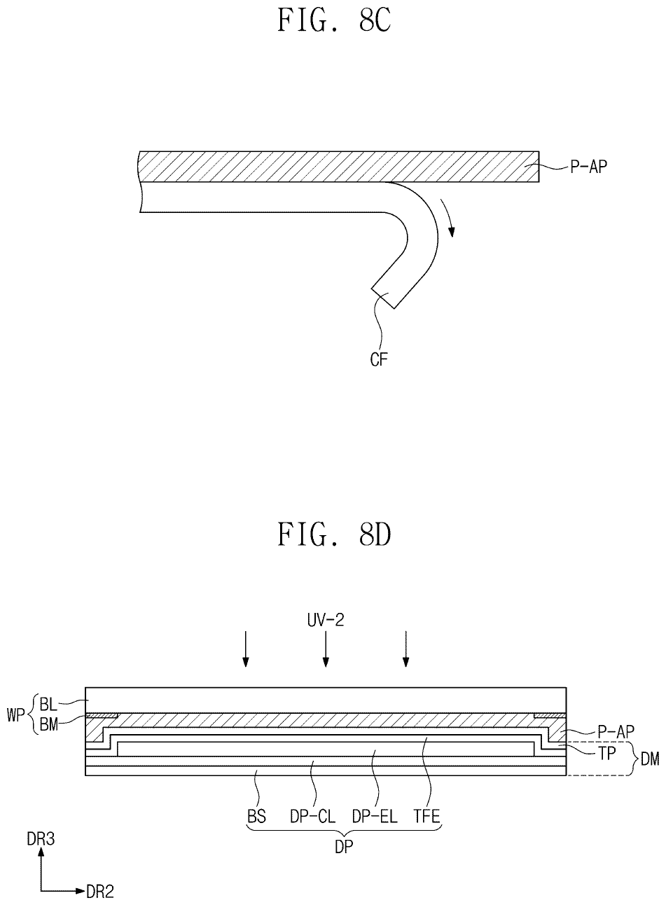

The adhesive member AP of one or more embodiments may include a polymer derived from the resin composition RC (see FIGS. 8A, 9A, and 10A) of one or more embodiments which will be described in more detail later. The adhesive member AP may be formed from the resin composition RC (see FIGS. 8A, 9A, and 10A) of one or more embodiments. The display device DD including the adhesive member AP formed from the resin composition RC (see FIGS. 8A, 9A, and 10A) of one or more embodiments may exhibit excellent or suitable display quality.

The window WP may include a glass substrate. The window WP may protect the display module DM, and/or the like. The image IM (see FIG. 1A) generated in the display module DM may be provided to a user by being transmitted through the window WP. For example, in one or more embodiments, the window WP may include ultra-thin glass (UTG).

The window WP may include a transmission region TA and a bezel region BZA. The transmission region TA may overlap at least a portion of the display region AA-DM of the display module DM. The transmission region TA may be an optically clear region. The image IM (see FIG. 1A) may be provided to a user through the transmission region TA.

The bezel region BZA may have a light transmittance relatively lower than the transmission region TA. The bezel region BZA may define the shape of the transmission region TA. The bezel region BZA may be adjacent to the transmission region TA, and may be around (e.g., surround) the transmission region TA.

In one or more embodiments, the bezel region BZA may have a certain color. The bezel region BZA may cover a non-display region NAA-DM of the display module DM to prevent the non-display region NAA-DM from being viewed from the outside. However, embodiments of the present disclosure are not limited to the configuration illustrated, for example, the bezel region BZA may be arranged adjacent to only one side of the transmission region TA, or at least a part thereof may not be provided.

The protective layer PF may be a functional layer that protects one surface (e.g., an upper surface) of the window WP. In one or more embodiments, the protective layer PF may include polyethylene terephthalate (PET). The protective layer PF may include an anti-fingerprint coating agent, a hard coating agent, an antistatic agent, and/or the like. In one or more embodiments, an auxiliary adhesive layer may be further arranged between the window WP and the protective layer PF, and the auxiliary adhesive layer may include a polymer derived from the resin composition RC (see FIGS. 8A, 9A, and 10A) of one or more embodiments which will be described in more detail later. Unlike the configuration illustrated, in some embodiments, the protective layer PF may not be provided.

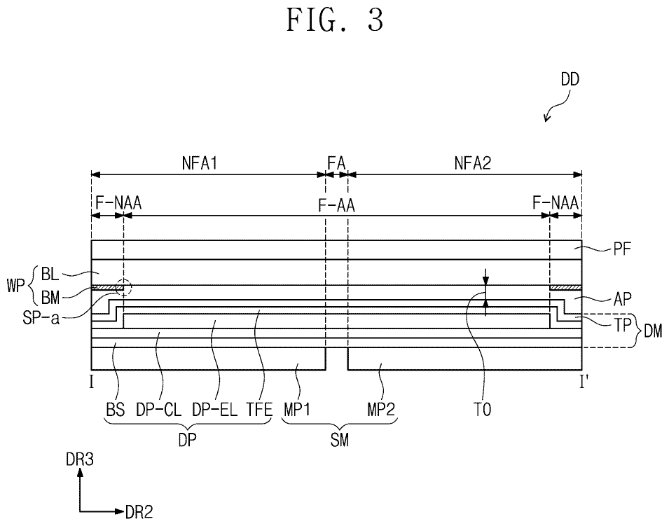

FIG. 3 is a cross-sectional view illustrating a portion corresponding to the line I-I′ of FIG. 2. FIG. 3 may be a cross-sectional view illustrating the display device DD according to one or more embodiments of the present disclosure. FIG. 3 illustrates the support member SM, the display module DM, the adhesive member AP, the window WP, and the protective layer PF with the housing HAU omitted for convenience of description.

Referring to FIG. 3, the support member SM may include a first support part MP1 overlapping the first non-folding region NFA1 and a second support part MP2 overlapping the second non-folding region NFA2. The first support part MP1 and the second support part MP2 may be spaced and/or apart (e.g., spaced apart or separated) from each other in the folding region FA. In one or more embodiments, the first support part MP1 and the second support part MP2 may not overlap the folding region FA. In one or more embodiments, at least a part of the first support part MP1 and at least a part of the second support part MP2 may each overlap the folding region FA.

The display module DM may include a display panel DP and an input sensing unit TP on the display panel DP. The display panel DP may include a base substrate BS, a circuit layer DP-CL on the base substrate BS, a display element layer DP-EL on the circuit layer DP-CL, and an encapsulation layer TFE covering the display element layer DP-EL. The adhesive member AP may be arranged between the display panel DP and the window WP.

The configuration of the display panel DP illustrated in FIG. 3 is merely an example, and the configuration of the display panel DP is not limited thereto. For example, in one or more embodiments, the display panel DP may include a liquid crystal display element, and in these embodiments, the encapsulation layer TFE may not be provided.

The base substrate BS may provide a base surface on which the circuit layer DP-CL is arranged. The base substrate BS may be a flexible substrate which is bendable, foldable, or rollable. The base substrate BS may be a glass substrate, a metal substrate, or a polymer substrate. However, embodiments of the present disclosure are not limited thereto, and the base substrate BS may be an inorganic layer, an organic layer, or a composite material layer.

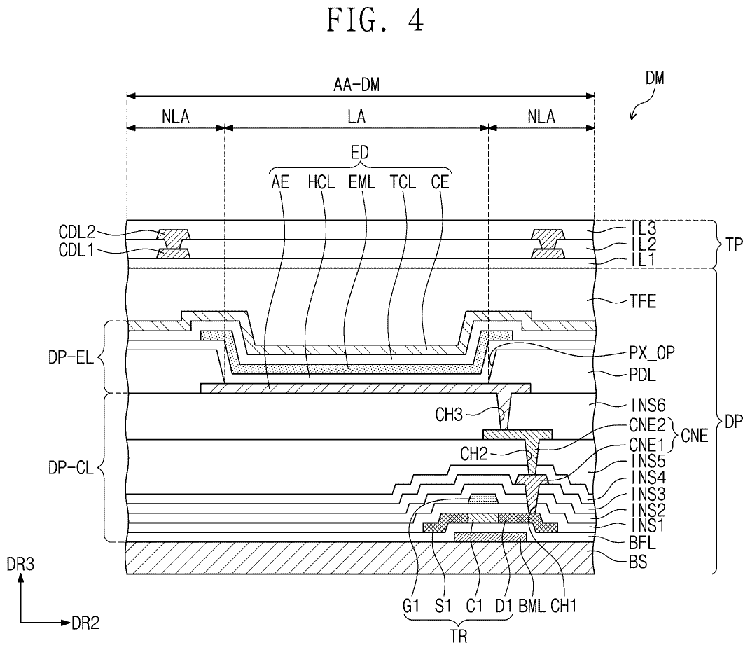

The circuit layer DP-CL may include an insulation layer, a semiconductor pattern, a conductive pattern, a signal line, and/or the like. For example, in one or more embodiments, the circuit layer DP-CL may include a switching transistor and a driving transistor for driving a light emitting element ED (see FIG. 4) of the display element layer DP-EL.

The display element layer DP-EL may include a light emitting element ED (see FIG. 4) which emits light. For example, in one or more embodiments, the light emitting element ED (see FIG. 4) may include organic light emitting materials, inorganic light emitting materials, organic-inorganic light emitting materials, quantum dots, quantum rods, micro LEDs, or nano LEDs.

The encapsulation layer TFE may be arranged on the display element layer DP-EL. The encapsulation layer TFE may protect the display element layer DP-EL from foreign substances such as moisture, oxygen, and/or the dust particles. In one or more embodiments, the encapsulation layer TFE may include at least one inorganic layer. In one or more embodiments, the encapsulation layer TFE may include at least one organic layer and at least one inorganic layer. For example, in some embodiments, the encapsulation layer TFE may include an inorganic layer, an organic layer, and an inorganic layer, which are sequentially stacked in the stated order.

The input sensing unit TP may be arranged on the display panel DP. For example, in one or more embodiments, the input sensing unit TP may be directly arranged on the encapsulation layer TFE of the display panel DP.

In the present disclosure, arranging/providing one component directly on another component refers to that a third component is not arranged/provided between one component and another component. For example, “arranging/providing” one component “directly” on another component refers to that one component is in “contact” with another component.

The input sensing unit TP may detect an external input, convert the external input to a set or predetermined input signal, and provide the input signal to the display panel DP. For example, in the display device DD of one or more embodiments, the input sensing unit TP may be a touch sensing unit that senses a touch. The input sensing unit TP may recognize a direct touch of a user, an indirect touch of a user, a direct touch of an object, or an indirect touch of an object.

The input sensing unit TP may sense at least one of a location of an externally applied touch or force (pressure) of the externally applied touch. In one or more embodiments, the input sensing unit TP may have one or more suitable structures or may be formed of one or more suitable materials, but embodiments of the present disclosure are not limited thereto. For example, the input sensing unit TP may sense an external input in a capacitive manner. The display panel DP may receive an input signal from the input sensing unit TP, and generate an image corresponding to the input signal.

The window WP may include a base layer BL and a printed layer BM. In one or more embodiments, the window WP may further include at least one functional layer provided on the base layer BL. For example, the functional layer may be a hard coating layer, an anti-fingerprint coating layer, and/or the like, but embodiments of the present disclosure are not limited thereto.

In one or more embodiments, the base layer BL may be a glass substrate. In one or more embodiments, the base layer BL may be a plastic substrate. For example, the base layer BL may be formed of polyimide, polyacrylate, polymethylmethacrylate, polycarbonate, polyethylenenaphthalate, polyvinylidene chloride, polyvinylidene difluoride, polystyrene, an ethylene-vinyl alcohol copolymer, and/or a (e.g., any suitable) combination thereof.

The printed layer BM may be arranged on one surface of the base layer BL. In one or more embodiments, the printed layer BM may be provided on a bottom surface of the base layer BL adjacent to the display module DM. The printed layer BM may be arranged in an edge region of the base layer BL. The printed layer BM may be an ink printed layer. In one or more embodiments, the printed layer BM may be a layer including a pigment and/or a dye. In the window WP, the bezel region BZA may be a portion in which the printed layer BM is provided.

A step SP-a may be present between the printed layer BM and a portion of the base layer BL on which the printed layer BM is not provided. The adhesive member AP formed from the resin composition RC (see FIGS. 8A, 9A, and 10A) according to one or more embodiments may adhere to the window WP at the step SP-a without delamination.

The adhesive member AP may be arranged between the display panel DP and the window WP. The adhesive member AP may be arranged between the window WP and the input sensing unit TP arranged on the display panel DP.

A thickness T0 of the adhesive member AP may be in a range of about 10 micrometers (μm) to about 500 μm or about 50 μm to about 200 μm. For example, in one or more embodiments, the thickness T0 of the adhesive member AP may be in a range of about 50 μm to about 100 μm. However, this is a mere example, and the thickness TO of the adhesive member AP is not limited thereto.

FIG. 4 is a cross-sectional view specifically illustrating the display module of FIG. 3. The configuration of the display module DM illustrated in FIG. 4 is only an example, and embodiments of the present disclosure are not limited thereto.

In FIG. 4, the base substrate BS may include a single layer or multiple layers. For example, in one or more embodiments, the base substrate BS may include a first synthetic resin layer, a multi-layered or single-layered inorganic layer, and a second synthetic resin layer arranged on the multi-layered or single-layered inorganic layer. Each of the first synthetic resin layer and the second synthetic resin layer may include a polyimide-based resin. In one or more embodiments, each of the first synthetic resin layer and the second synthetic resin layer may independently include at least one of an acrylic-based resin, a methacrylic-based resin, a polyisoprene-based resin, a vinyl-based resin, an epoxy-based resin, a urethane-based resin, a cellulose-based resin, a siloxane-based resin, a polyamide-based resin, or a perylene-based resin. In the present disclosure, “something”-based resin refers to including a functional group of “something.”

The display panel DP may include a transistor TR and a light emitting element ED. The transistor TR and the light emitting element ED may each be arranged on the base substrate BS. Although FIG. 4 illustrates one transistor TR, the display panel DP may include a plurality of transistors and at least one capacitor for substantially driving the light emitting element ED.

The circuit layer DP-CL may be arranged on the base substrate BS. The circuit layer DP-CL may include a shielding electrode BML, the transistor TR, a connection electrode CNE, and a plurality of insulation layers BFL and INS1 to INS6. The plurality of insulation layers BFL and INS1 to INS6 may include a buffer layer BFL and first to sixth insulation layers INS1 to INS6. However, the stacked structure of the circuit layer DP-CL illustrated in FIG. 4 is merely an example, and the stacked structure of the circuit layer DP-CL may be changed according to the configuration of the display panel DP and the process of the circuit layer DP-CL and/or the like.

The shielding electrode BML may be arranged on the base substrate BS. The shielding electrode BML may overlap the transistor TR. The shielding electrode BML may protect the transistor TR by blocking light incident on the transistor TR from a lower portion of the display panel DP. The shielding electrode BML may include a conductive material (e.g., electron conductor). When a voltage is applied to the shielding electrode BML, a threshold voltage of the transistor TR arranged on the shielding electrode BML may be maintained. However, embodiments of the present disclosure are not limited thereto, and, for example, the shielding electrode BML may be a floating electrode. In some embodiments, the shielding electrode BML may not be provided.

The buffer layer BFL may be arranged on the base substrate BS to cover the shielding electrode BML. The buffer layer BFL may include an inorganic layer. The buffer layer BFL may improve a bonding force between the base substrate BS and a semiconductor pattern or a conductive pattern arranged on the buffer layer BFL.

The transistor TR may include a source S1, a channel C1, a drain D1, and a gate G1. The source S1, the channel C1, and the drain D1 of the transistor TR may each be formed from a semiconductor pattern. The semiconductor pattern of the transistor TR may include polysilicon, amorphous silicon, or a metal oxide, and is not limited to any material as long as it has a semiconductor property.

The semiconductor pattern may include a plurality of regions divided according to the magnitude of conductivity. A region of the semiconductor pattern doped with a dopant or a region in which a metal oxide is reduced may have high conductivity and may substantially serve as a source electrode or a drain electrode of the transistor TR. A region of the semiconductor pattern having high conductivity may correspond to the source S1 or the drain D1 of the transistor TR. A region of the semiconductor pattern, which is undoped or doped at a low concentration or has low conductivity due to the non-reduction of a metal oxide, may correspond to the channel C1 (or active) of the transistor TR.

The first insulation layer INS1 may be arranged on the buffer layer BFL while covering the semiconductor pattern of the transistor TR. The gate G1 of the transistor TR may be arranged on the first insulation layer INS1. On a plane (e.g., in a plan view of the display device), the gate G1 may overlap the channel C1 of the transistor TR. The gate G1 may function as a mask in a process of doping the semiconductor pattern of the transistor TR.

The second insulation layer INS2 may be arranged on the first insulation layer INS1 while covering the gate G1. The third insulation layer INS3 may be arranged on the second insulation layer INS2.

The connection electrode CNE may include a first connection electrode CNE1 and a second connection electrode CNE2 for electrically connecting the transistor TR and the light emitting element ED. However, the configuration of the connection electrode CNE for electrically connecting the transistor TR and the light emitting element ED is not limited thereto, in one or more embodiments, one selected from among the first and second connection electrodes CNE1 and CNE2 may not be provided, or an additional connection electrode may be further included.

The first connection electrode CNE1 may be arranged on the third insulation layer INS3. The first connection electrode CNE1 may be connected to the drain D1 through a first contact hole CH1 that penetrates the first to third insulation layers INS1 to INS3. The fourth insulation layer INS4 may be arranged on the third insulation layer INS3 while covering the first connection electrode CNE1. The fifth insulation layer INS5 may be arranged on the fourth insulation layer INS4.

The second connection electrode CNE2 may be arranged on the fifth insulation layer INS5. The second connection electrode CNE2 may be connected to the first connection electrode CNE1 through a second contact hole CH2 that penetrates the fourth and fifth insulation layers INS4 and INS5. The sixth insulation layer INS6 may be arranged on the fifth insulation layer INS5 while covering the second connection electrode CNE2.

Each of the first to sixth insulation layers INS1 to INS6 may include an inorganic layer or an organic layer. For example, the inorganic layer may include at least one of aluminum oxide, titanium oxide, silicon oxide, silicon oxynitride, zirconium oxide, or hafnium oxide. The organic layer may include at least one of an acrylic-based resin, a methacrylic-based resin, a polyisoprene-based resin, a vinyl-based resin, an epoxy-based resin, a urethane-based resin, a cellulose-based resin, a siloxane-based resin, a polyamide-based resin, or a perylene-based resin.

The display element layer DP-EL may include a pixel defining film PDL and the light emitting element ED. The light emitting element ED may include a first electrode AE, a hole control layer HCL, an emission layer EML, an electron control layer TCL, and a second electrode CE.

The first electrode AE may be arranged on the sixth insulation layer INS6. The first electrode AE may be connected to the second connection electrode CNE2 through a third contact hole CH3 that penetrates the sixth insulation layer INS6. The first electrode AE may be electrically connected to the drain D1 of the transistor TR through the first and second connection electrodes CNE1 and CNE2.

The first electrode AE may be formed of a metal material, a metal alloy, or a conductive compound. The first electrode AE may be an anode or a cathode. However, embodiments of the present disclosure are not limited thereto. In addition, the first electrode AE may be a pixel electrode. The first electrode AE may be a transmissive electrode, a transflective electrode, or a reflective electrode. The first electrode AE may include at least one selected from among silver (Ag), magnesium (Mg), copper (Cu), aluminum (AI), platinum (Pt), palladium (Pd), gold (Au), nickel (Ni), neodymium (Nd), iridium (Ir), chromium (Cr), lithium (Li), calcium (Ca), lithium fluoride (LiF), molybdenum (Mo), titanium (Ti), tungsten (W), indium (In), tin (Sn), and zinc (Zn), a compound of two or more selected from therefrom, a mixture of two or more selected from therefrom, or an oxide thereof.

If (e.g., when) the first electrode AE is the transmissive electrode, the first electrode AE may include a transparent metal oxide such as indium tin oxide (ITO), indium zinc oxide (IZO), zinc oxide (ZnO), and/or indium tin zinc oxide (ITZO). If (e.g., when) the first electrode AE is the transflective electrode or the reflective electrode, the first electrode AE may include Ag, Mg, Cu, Al, Pt, Pd, Au, Ni, Nd, Ir, Cr, Li, Ca, LiF/Ca (a stacked structure of LiF and Ca), LiF/Al (a stacked structure of LiF and Al), Mo, Ti, W, or a compound or a mixture thereof (e.g., a mixture of Ag and Mg). In one or more embodiments, the first electrode AE may have a multilayer structure including a reflective film or a transflective film formed of one or more of the above-described materials, and a transparent conductive film formed of ITO, IZO, ZnO, ITZO, and/or the like. For example, in one or more embodiments, the first electrode AE may have a three-layered structure of ITO/Ag/ITO, but embodiments of the present disclosure are not limited thereto. In one or more embodiments, the first electrode AE may include one of the above-described metal materials, a combination of at least two metal materials of the above-described metal materials, an oxide of any one of the above-described metal materials, and/or the like.

The pixel defining film PDL may be arranged on the sixth insulation layer INS6. In the pixel defining film PDL, an emission opening PX_OP for exposing a portion of the first electrode AE may be defined. The portion of the first electrode AE exposed by the emission opening PX_OP may be defined as a light emitting region LA.

The display region AA-DM of the display module DM may include the light emitting region LA and a light-blocking region NLA. A region in which the pixel defining film PDL is arranged may correspond to the light-blocking region NLA. The light-blocking region NLA may be around (e.g., surround) the light emitting region LA in the display region AA-DM.

In one or more embodiments, the hole control layer HCL may be arranged on the first electrode AE and the pixel defining film PDL. The hole control layer HCL may be provided as a common layer that overlaps the light emitting region LA and the light-blocking region NLA. Unlike this, in one or more embodiments, the hole control layer HCL may be provided only in the region corresponding to the emission opening PX_OP. The hole control layer HCL may include at least one of a hole transport layer, a hole injection layer, or an electron blocking layer. The hole control layer HCL may include a suitable hole injection material and/or a suitable hole transport material.

The emission layer EML may be arranged on the hole control layer HCL. In one or more embodiments, the emission layer EML may be arranged in the region corresponding to the emission opening PX_OP. In one or more embodiments, the emission layer EML may be provided as a common layer. The emission layer EML may include an organic light emitting material and/or an inorganic light emitting material. The emission layer EML may be to emit any one color light of red, green, or blue. For example, in one or more embodiments, the emission layer EML may be to emit blue light.

The electron control layer TCL may be arranged on the emission layer EML. In one or more embodiments, the electron control layer TCL may be provided as a common layer that overlaps the light emitting region LA and the light-blocking region NLA. In one or more embodiments, the electron control layer TCL may be provided only in the region corresponding to the emission opening PX_OP. The electron control layer TCL may include at least one of an electron transport layer, an electron injection layer, or a hole blocking layer. The electron control layer TCL may include a suitable electron injection material and/or a suitable electron transport material.

The second electrode CE may be arranged on the electron control layer TCL. The second electrode CE may be provided as a common layer that overlaps the light emitting region LA and the light-blocking region NLA.

The second electrode CE may be a common electrode. The second electrode CE may be a cathode or an anode, but embodiments of the present disclosure are not limited thereto. For example, if (e.g., when) the first electrode AE is an anode, the second electrode CE may be a cathode, and if (e.g., when) the first electrode AE is a cathode, the second electrode CE may be an anode.

The second electrode CE may be a transmissive electrode, a transflective electrode, or a reflective electrode. If (e.g., when) the second electrode CE is the transmissive electrode, the second electrode CE may be formed of a transparent metal oxide such as ITO, IZO, ZnO, or ITZO.

If (e.g., when) the second electrode CE is the transflective electrode or the reflective electrode, the second electrode CE may include Ag, Mg, Cu, Al, Pt, Pd, Au, Ni, Nd, Ir, Cr, Li, Ca, LiF/Ca, LiF/AI, Mo, Ti, Yb, W, or a compound or a mixture thereof (e.g., AgMg, AgYb, or MgYb). In one or more embodiments, the second electrode CE may have a multi-layered structure including a reflective film or a transflective film formed of one or more of the above-described materials, and a transparent conductive film formed of ITO, IZO, ZnO, ITZO, and/or the like. For example, in one or more embodiments, the second electrode CE may include one of the above-described metal materials, a combination of at least two metal materials selected from among the above-described metal materials, an oxide any one of the above-described metal materials, and/or the like.

The encapsulation layer TFE may be arranged on the second electrode CE to cover the light emitting element ED. The encapsulation layer TFE may include a plurality of thin films. For example, in one or more embodiments, the encapsulation layer TFE may include inorganic films arranged on the second electrode CE and an organic film arranged between the inorganic films. The inorganic films protect the light emitting element ED from moisture/oxygen, and the organic film protects the light emitting element ED from foreign substances such as dust particles.

The input sensing unit TP may include a first sensing insulation layer IL1, a second sensing insulation layer IL2, and a third sensing insulation layer IL3. The input sensing unit TP may include at least one conductive layer arranged on the sensing insulation layers. The input sensing unit TP may include a first conductive layer CDL1 and a second conductive layer CDL2.

The first sensing insulation layer IL1 may be arranged on the encapsulation layer TFE. The first sensing insulation layer IL1 may include at least one inorganic insulation layer. The first sensing insulation layer IL1 may be in contact with the encapsulation layer TFE. In one or more embodiments, the first sensing insulation layer IL1 may not be provided, and in these embodiments, the first conductive layer CDL1 may be in contact with the encapsulation layer TFE.

The first conductive layer CDL1 may be arranged on the first sensing insulation layer IL1. The first conductive layer CDL1 may include a plurality of first conductive patterns. The plurality of first conductive patterns may be arranged on the first sensing insulation layer IL1. The second sensing insulation layer IL2 may be arranged on the first sensing insulation layer IL1 to cover at least a portion of the first conductive layer CDL1.

The second conductive layer CDL2 may be arranged on the second sensing insulation layer IL2. The second conductive layer CDL2 may include a plurality of second conductive patterns. The plurality of second conductive patterns may be arranged on the second sensing insulation layer IL2. Each of the plurality of second conductive patterns may be connected to the plurality of first conductive patterns through a contact hole formed in the second sensing insulation layer IL2.

Each of the plurality of first conductive patterns of the first conductive layer CDL1 and the plurality of second conductive patterns of the second conductive layer CDL2 may be arranged to correspond to the light-blocking region NLA. Each of the plurality of first conductive patterns CP1 of the first conductive layer CDL1 and the plurality of second conductive patterns CP2 of the second conductive layer CDL2 may correspond to a mesh pattern.

The third sensing insulation layer IL3 may be arranged on the second sensing insulation layer IL2 and may cover the second conductive layer CDL2. Each of the second sensing insulation layer IL2 and the third sensing insulation layer IL3 may include an inorganic insulation layer or an organic insulation layer.

Each of the first conductive layer CDL1 and the second conductive layer CDL2 may have a single-layered structure or a multi-layered structure stacked in the third direction DR3. The single-layered conductive layers CDL1 and CDL2 may each include a metal layer or a transparent conductive layer. The metal layer may include molybdenum, silver, titanium, copper, aluminum, or an alloy thereof. The transparent conductive layer may include a transparent conductive oxide such as ITO, IZO, ZnO, or IZTO. In one or more embodiments, the transparent conductive layer may include a conductive polymer such as poly(3,4-ethylenedioxythiophene) (PEDOT), a metal nanowire, graphene, and/or the like.

The multi-layered conductive layers CDL1 and CDL2 may each include metal layers. The metal layers may have, for example, a three-layer structure of titanium (Ti)/aluminum (AI)/titanium (Ti). In one or more embodiments, the multi-layered conductive layers CDL1 and CDL2 may each include at least one metal layer and at least one transparent conductive layer.

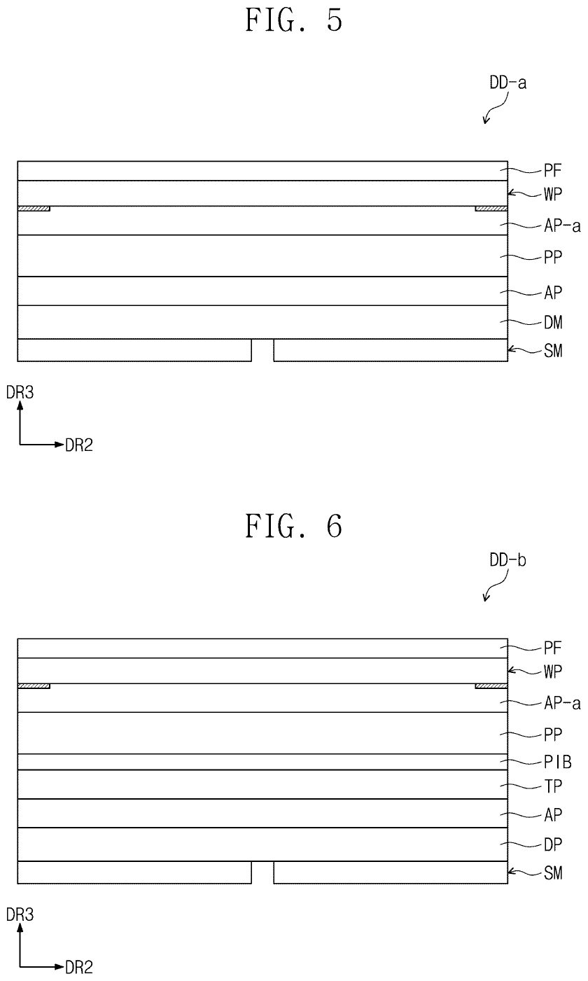

FIG. 5 is a cross-sectional view illustrating a display device DD-a according to one or more embodiments of the present disclosure. Hereinafter, in the description of the display device DD-a illustrated in FIG. 5, the duplicated features which have been described with reference to FIGS. 1 to 4 will not be described again, and instead, only their differences will be mainly described.

The display device DD-a illustrated in FIG. 5 may further include a light control layer PP and an optical adhesive layer AP-a as compared with the display device DD described with reference to FIGS. 2 and 3. The display device DD-a according to one or more embodiments may further include the light control layer PP arranged between the adhesive member AP and the window WP, and the optical adhesive layer AP-a arranged between the light control layer PP and the window WP. The optical adhesive layer AP-a may be arranged directly on the light control layer PP. The light control layer PP may include a polarization plate and/or a color filter layer.

The optical adhesive layer AP-a may be formed from the resin composition RC (see FIGS. 8A, 9A, and 10A) of one or more embodiments. The optical adhesive layer AP-a including a polymer derived from the resin composition RC (see FIGS. 8A, 9A, and 10A) of one or more embodiments may be optically clear. The display device DD-a including the optical adhesive layer AP-a including the polymer derived from the resin composition RC (see FIGS. 8A, 9A, and 10A) of one or more embodiments may exhibit excellent or suitable display quality.

FIG. 6 is a cross-sectional view illustrating a display device DD-b according to one or more embodiments of the present disclosure. Hereinafter, in the description of the display device DD-b of one or more embodiments illustrated in FIG. 6, the duplicated features which have been described with reference to FIGS. 1 to 5 will not be described again, and instead, only their differences will be mainly described.

The display device DD-b of one or more embodiments illustrated in FIG. 6 may further include a light control layer PP, an optical adhesive layer AP-a, and an interlayer adhesive layer PIB as compared with the display device DD described with reference to FIGS. 2 and 3. The display device DD-b of one or more embodiments illustrated in FIG. 6 may further include the light control layer PP arranged between the adhesive member AP and the window WP, and the optical adhesive layer AP-a arranged between the light control layer PP and the window WP, like the display device DD-a of one or more embodiments illustrated in FIG. 5.

In the display device DD-b of one or more embodiments, the adhesive member AP may be provided between the display panel DP and the input sensing unit TP. For example, in one or more embodiments, the input sensing unit TP may not be arranged directly on the display panel DP, and the display panel DP and the input sensing unit TP may be coupled to each other via the adhesive member AP. For example, in one or more embodiments, the adhesive member AP and may be arranged between the encapsulation layer TFE (see FIG. 3) of the display panel DP and the input sensing unit TP.

The interlayer adhesive layer PIB may be provided to a bottom side of the light control layer PP. The interlayer adhesive layer PIB may be arranged between the input sensing unit TP and the light control layer PP, and be formed of an adhesive material having superior anti-moisture permeability. For example, in one or more embodiments, the interlayer adhesive layer PIB may include polyisobutylene. The interlayer adhesive layer PIB may be arranged on the input sensing unit TP to prevent or reduce corrosion of sensing electrodes of the input sensing unit TP. The display device DD-b of one or more embodiments may include the optical adhesive layer AP-a and the adhesive member AP each formed from the resin composition RC (FIGS. 8A, 9A, and 10A) according to one or more embodiments, and the display device DD-b including the optical adhesive layer AP-a and the adhesive member AP may exhibit excellent or suitable display quality.

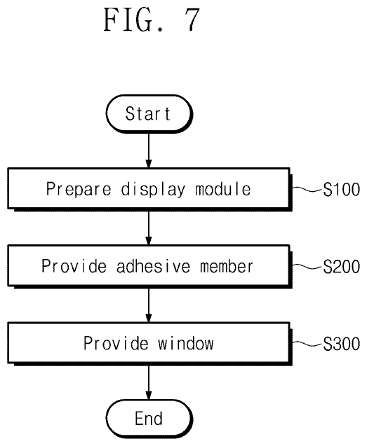

The display device according one or more embodiments may be prepared by a method for manufacturing a display device of one or more embodiments of the present disclosure. The method for manufacturing a display device of one or more embodiments may include providing an adhesive member according of one or more embodiments of the present disclosure. FIG. 7 is a flowchart showing a method for manufacturing a display device of one or more embodiments. FIGS. 8A to 8D are each a view schematically illustrating a method for manufacturing a display device of one or more embodiments. Hereinafter, in the description of FIGS. 7 and 8A to 8D, the duplicated features which have been described with reference to FIGS. 1 to 6 will not be described again, and instead, only their differences will be mainly described.

Referring to FIG. 7, the method for manufacturing a display device of one or more embodiments may include preparing a display module (S100), providing an adhesive member (S200), and providing a window (S300). The window WP (see FIG. 8D) may be provided on the display module DM (see FIG. 8D). The providing of the adhesive member AP (see FIGS. 3 and 5) may include providing a resin composition RC (see FIG. 8A) of one or more embodiments and then providing light UV-1 and UV-2 (see FIGS. 8B and 8D) to the resin composition RC (see FIG. 8A) to form the adhesive member AP (see FIGS. 3 and 5).

Referring to FIG. 8A, the resin composition RC (e.g., in a form of liquid) may be provided on a temporary substrate CF. The resin composition RC may be provided on the temporary substrate CF through a nozzle NZ. For example, the temporary substrate CF on which the resin composition RC is provided may include polyethylene terephthalate (PET). The temporary substrate CF is a temporary substrate used to form the adhesive member AP (see FIG. 3) from the resin composition RC, and any substrate may be used without limitation as long as the resin composition RC may be easily detached after being cured. Release treatment may be conducted on one surface of the temporary substrate CF on which the resin composition RC is provided.

The resin composition RC of one or more embodiments may be provided by an inkjet printing method or a dispensing method. If (e.g., when) the resin composition RC is provided by the inkjet printing method or the dispensing method, the resin composition RC may exhibit easy applicability on members of one or more suitable forms included in the display devices DD, DD-a, and DD-b (see FIGS. 1A, 5, and 6).

In one or more embodiments, the liquid resin composition RC may be provided in a substantially uniform amount and/or at a substantially uniform speed. Although FIG. 5A illustrates that the resin composition RC is provided through the nozzle NZ, a device for providing the resin composition RC is not limited thereto.

The resin composition RC of one or more embodiments may have a viscosity of about 5 mPa·s to about 20 mPa·s as measured at about 25° C. by the JIS K7117-2 method. The resin composition RC having a viscosity of about 5 mPa·s to about 20 mPa·s as measured at about 25° C. by the JIS K7117-2 method exhibits low viscosity characteristics, and thus may be provided by the inkjet printing method or the dispensing method. A resin composition having a viscosity of less than about 5 mPa·s as measured at about 25° C. by the JIS K7117-2 method generates a flow if (e.g., when) the resin composition is provided. The term “flow” refers to a phenomenon in which the resin composition flows out of a member to which the resin composition is to be provided. The resin composition having a viscosity of greater than about 20 mPa·s as measured at about 25° C. by the JIS K7117-2 method may cause clogging if (e.g., when) discharged from a device such as a nozzle NZ, and may not be applied in a substantially uniform amount and/or at a substantially uniform speed. The entire disclosure of JIS K7117-2, “Plastics-Polymers/resins In The Liquid State Or As Emulsions Or Dispersions—Determination Of Viscosity Using A Rotational Viscometer With Defined Shear Rate”, is incorporated herein by reference.

The resin composition RC of one or more embodiments may include at least one urethane (meth)acrylate, at least one monofunctional (meth)acrylate monomer, at least one photoinitiator, and a polyether-modified dimethylsiloxane. In the present disclosure, the (meth)acryloyl group refers to an acryloyl group or a methacryloyl group, and the (meth)acryl refers to acryl or methacryl.

The resin composition RC of one or more embodiments does not include a (any) polyfunctional (meth)acrylate monomer. The resin composition RC of one or more embodiments does not include a (any) polyfunctional ethylenically unsaturated monomer having no urethane group. The resin composition including the polyfunctional (meth)acrylate monomer exhibits low flexibility after curing, and is not suitable for a flexible display device. Because the resin composition RC of one or more embodiments does not include any (of the) polyfunctional (meth)acrylate, the resin composition RC exhibits excellent or suitable flexibility after curing, and may be provided as the adhesive member AP (see FIGS. 3, 5, and 6) constituting a flexible display device.

In the resin composition RC of one or more embodiments, the urethane (meth)acrylate may be an oligomer. In one or more embodiments, the urethane (meth)acrylate of the resin composition RC may have a weight-average molecular weight (Mw) of about 5,000 to about 50,000. The urethane (meth)acrylate having a weight-average molecular weight of about 5,000 to about 50,000 is included in the resin composition RC in a state having a relatively high degree of polymerization, and may maintain a high degree of polymerization even after curing. The resin composition RC including the urethane (meth)acrylate having a weight-average molecular weight of about 5,000 to about 50,000 may satisfy the above-described viscosity range. For example, in one or more embodiments, the urethane (meth)acrylate may include at least one of UF-C051 (urethane acrylate produced by Kyoeisha Chemical Co., Ltd) or UN6304 (urethane acrylate produced by Negami Chemical Industrial Co., Ltd). However, this is merely an example, and the urethane (meth)acrylate is not limited thereto.

The resin composition RC of one or more embodiments may include at least one monofunctional (meth)acrylate monomer. For example, the monofunctional (meth)acrylate monomer may include at least one of hydroxyl group-containing (meth)acrylate or alkyl (meth)acrylate. In one or more embodiments, the monofunctional (meth)acrylate monomer may include at least one of 4-hydroxybutyl acrylate (4-HBA) or 2-ethylhexyl acrylate (2-EHA). However, this is merely an example, and the monofunctional (meth)acrylate monomer is not limited thereto.

In the resin composition RC, a weight of the monofunctional (meth)acrylate monomer may be about 87 wt % to about 93 wt % based on the sum (100 wt %) of a weight of the urethane (meth)acrylate and the weight of the monofunctional (meth)acrylate monomer. The resin composition RC including the monofunctional (meth)acrylate monomer meeting the weight range may meet and satisfy the above-described viscosity range.

The resin composition RC may include at least one photoinitiator. The photoinitiator may include a radical polymerization initiator. For example, in one or more embodiments, the radical polymerization initiator may include phenylbis(2,4,6-trimethylbenzoyl)phosphine oxide.

In one or more embodiments, the resin composition RC may include a plurality of photoinitiators. If (e.g., when) the resin composition RC includes a plurality of photoinitiators, different photoinitiators may be activated by ultraviolet light having different center wavelengths. For example, the photoinitiator may include at least one of 2,2-dimethoxy-1,2-diphenylethan-1-one, 1-hydroxy cyclohexyl-phenylketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one.

In addition, the photoinitiator may include at least one of 2-methyl-1-[4-(methylthio)phenyl]-2-morpholinopropan-1-one, 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, [1-(4-phenylsulfanylbenzoyl)heptylideneamino]benzoate), [1-[9-ethyl-6-(2-methylbenzoyl)carbazol-3-yl]ethylideneamino]acetate, or bis(2,4-cyclopentadienyl)bis[2,6-difluoro-3-(pyrrol-1-yl)phenyl]titanium(IV).

The resin composition RC of one or more embodiments may include a polyether-modified dimethylsiloxane. The polyether-modified dimethylsiloxane includes a polyether group and a dimethylsiloxane group, and may have a number-average molecular weight (Mn) of about 1,000 to about 30,000. Based on 100% of the total molecular weight (i.e., number-average molecular weight) of the polyether-modified dimethylsiloxane, a molecular weight of the dimethylsiloxane group (e.g., a molecular weight attributed to the dimethylsiloxane group) may be in a range of about 15% to about 90%.

In the resin composition RC, the polyether-modified dimethylsiloxane may be an additive. In one or more embodiments, if (e.g., when) the sum of the weight of the urethane (meth)acrylate and the weight of the monofunctional (meth)acrylate monomer is 100 parts by weight, a weight of the polyether-modified dimethylsiloxane may be in a range of about 0.001 parts by weight to about 0.1 parts by weight. For example, if (e.g., when) the sum of the weight of the urethane (meth)acrylate and the weight of the monofunctional (meth)acrylate monomer is 100 g (gram), the polyether-modified dimethylsiloxane may be provided in a weight of about 0.001 g to about 0.1 g.

The resin composition RC including a dimethylsiloxane group satisfying the above-described molecular weight range and including a polyether-modified dimethylsiloxane satisfying the above-described weight range may prevent or reduce wetting and spreading, and may exhibit a pinning effect. The pinning effect refers to a phenomenon in which when a liquid composition is provided on a desired or suitable member, and in a formed droplet, a substantial spread does not occur, and the droplet is attached to the surface of the member. The dimethylsiloxane group may be a component that affects the surface tension of a fluid including polyether-modified dimethylsiloxane (i.e., a resin composition). The polyether group may be a component that affects compatibility with other materials included in the resin composition. When the dimethylsiloxane group satisfies the above-described molecular weight range and the polyether-modified dimethylsiloxane satisfies the above-described weight range, the compatibility with respect to the resin composition RC may be excellent or suitable, the surface tension of the resin composition RC may be adjusted to a desired or suitable level, and the pinning effect may be exhibited. Accordingly, the resin composition RC including the polyether-modified dimethylsiloxane may exhibit a characteristic such that it is likely to be precisely applied to members of one or more suitable forms which constitute the display devices DD, DD-a, and DD-b (see FIGS. 1A, 5, and 6).

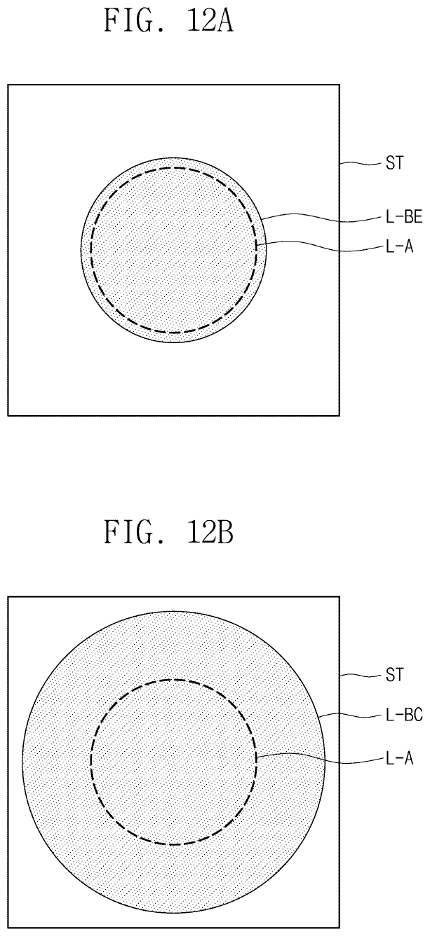

The resin composition RC of one or more embodiments may satisfy Expression 1. Expression 1 may be an expression relating to the diameter of a droplet measured by providing the resin composition RC according to the JIS R 3257 method. The droplet may be formed by providing the resin composition RC on a member ST (see FIGS. 12A and 12B) for evaluation according to the JIS R 3257 method. Expression 1 may be an expression regarding a first diameter measured after 1 second and a second diameter measured after 60 seconds with respect to a droplet formed from the resin composition RC. The entire disclosure of JIS R 3257, “Testing Method Of Wettability Of Glass Substrate”, is incorporated herein by reference.

$$1. \leq {D}_{L} \leq 1.2 \qquad Expression 1$$

In Expression 1, D_{L} may be a ratio of the second diameter to the first diameter. For example, D_{L} may be a value obtained by dividing the second diameter by the first diameter. The first diameter and the second diameter are measured for the same droplet. The diameter of the droplet may vary over time after the providing of the resin composition.

The droplet provided from the resin composition having relatively small wettability and spreadability may exhibit a value in which a ratio of the second diameter to the first diameter is small. In one or more embodiments, the droplets provided from the resin composition having relatively small wettability and spreadability may exhibit a value in which the ratio of the second diameter to the first diameter is close to 1. For example, for the droplet provided from the resin composition having relatively small wettability and spreadability, the first diameter and the second diameter may have a similar level as the size of the droplet does not change significantly over time.

As described above, the resin composition RC of one or more embodiments may include the polyether-modified dimethylsiloxane, thereby preventing or reducing wetting and spreading and exhibiting the pinning effect. Thus, the resin composition RC of one or more embodiments may satisfy Expression 1. For example, in the resin composition RC of one or more embodiments, the ratio of the second diameter to the first diameter (i.e., D_{L}) may be about 1.0 to about 1.2.

In contrast, droplets provided from a resin composition having relatively high wettability and spreadability exhibit a value in which the ratio of the second diameter to the first diameter is large. For example, the droplets provided from a resin composition having relatively high wettability and spreadability exhibit a value in which the second diameter is larger than the first diameter and D_{L} greater than about 1.2 as the size of the droplet increases significantly over time.

The resin composition RC of one or more embodiments may include the above-described urethane (meth)acrylate, the monofunctional (meth)acrylate monomer, the photoinitiator, and the polyether-modified dimethylsiloxane. Accordingly, the resin composition RC of one or more embodiments may exhibit a low viscosity that may be provided by an inkjet printing method and/or the like, and may exhibit a characteristic such that it is likely to be precisely applied. The method for manufacturing a display device of one or more embodiments, by including the providing of the resin composition RC of one or more embodiments, may exhibit excellent or suitable manufacture efficiency.

Referring to FIG. 8B, first light UV-1 may be provided to the resin composition RC applied to a substantially uniform thickness on the temporary substrate CF. The resin composition RC in a liquid phase may be cured by the first light UV-1 to form a preliminary adhesive member P-AP (see FIG. 8C). The first light UV-1 may be ultraviolet light. FIG. 8B illustrates that the resin composition RC applied on the temporary substrate CF is directly irradiated with the first light UV-1 to form the preliminary adhesive member P-AP (see FIG. 8C), but embodiments of the present disclosure are not limited thereto. In one or more embodiments, a carrier film may be arranged on the resin composition RC applied in a substantially uniform thickness, and may be to transmit ultraviolet light (e.g., transparent to ultraviolet light).

Referring to FIG. 8C and FIG. 8D, the preliminary adhesive member P-AP formed by irradiating the resin composition RC with the first light UV-1 (see FIG. 8B) may be detached from the temporary substrate CF and provided on one surface of the window WP or on one surface of the display module DM. One surface of the preliminary adhesive member P-AP may be laminated on one surface of the window WP or on one surface of the display module DM, and one surface of the display module DM or one surface of the window WP, which is not attached, may be attached to the other surface of the preliminary adhesive member P-AP. Then, the adhesive member AP (see FIGS. 3 and 5) may be formed by irradiating the preliminary adhesive member P-AP with second light UV-2. The second light UV-2 may be ultraviolet light. The second light UV-2 may be provided from above the window WP, and the window WP may be to transmit the second light UV-2 (e.g., transparent to the second light UV-2). The second light UV-2 may pass through the window WP to be provided to the preliminary adhesive member P-AP.

In one or more embodiments, FIGS. 8A to 8D illustrate that the resin composition RC is cured twice (that is, cured by providing light twice) to form the adhesive member AP (see FIGS. 3 and 5), but embodiments of the present disclosure are not limited thereto. For example, in some embodiments, the adhesive member AP (see FIGS. 3 and 5) may be formed by curing the resin composition RC (see FIG. 8A) once, or the adhesive member AP (see FIGS. 3 and 5) may be formed by curing the resin composition RS three times or more.

The resin composition RC (see FIG. 8A) of one or more embodiments may be cured by light UV-1 and UV-2. For example, the resin composition RC (see FIG. 8A) may be cured by ultraviolet light to form the adhesive member AP (see FIGS. 3 and 5). The resin composition RC (see FIG. 8A) of one or more embodiments may exhibit excellent or suitable uniformity before and after curing. Excellent uniformity may refer to that solubility before curing is excellent or suitable, no suspension and white turbidity are observed, and the resin composition after curing is optically clear. In the resin composition RC (FIG. 8A) of one or more embodiments, materials (i.e., urethane (meth)acrylate, monofunctional (meth)acrylate monomer, photoinitiator, and polyether-modified dimethylsiloxane) constituting the resin composition RC (FIG. 8A) may be uniformly (e.g., substantially uniformly) dissolved, and no suspension and white turbidity may be observed. The resin composition RC (see FIG. 8A) of one or more embodiments may be optically clear after being cured by light. The term “optically clear” may refer to that the transmittance of light in the visible wavelength region is about 80% or more.

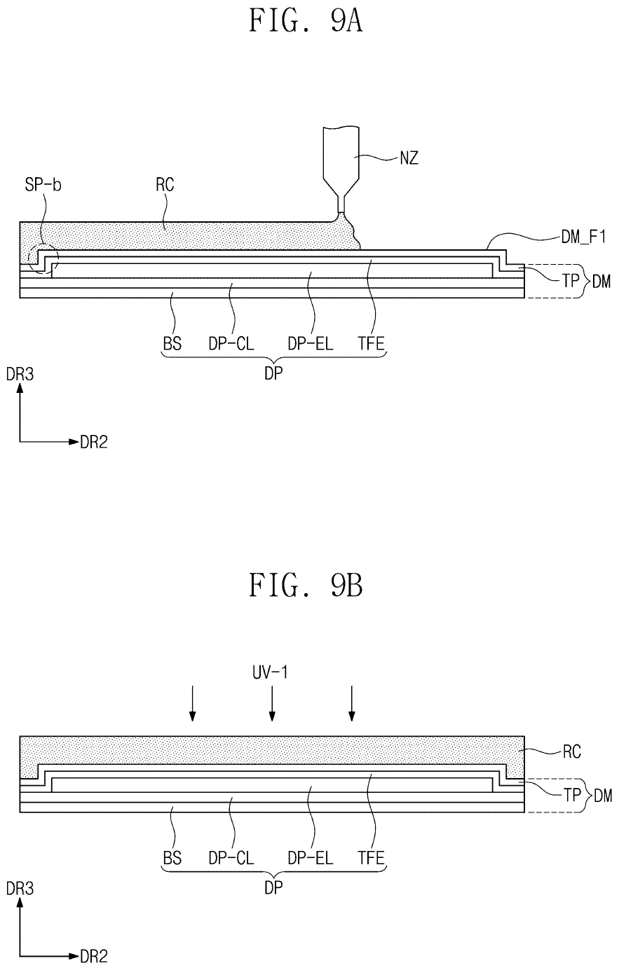

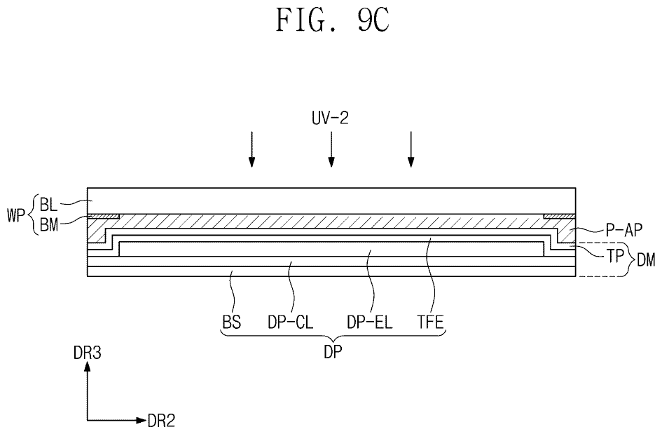

FIGS. 9A to 9C are each a view schematically illustrating a method for manufacturing a display device according to one or more embodiments of the present disclosure. Hereinafter, in the description of FIGS. 9A to 9C, the duplicated features which have been described with reference to FIGS. 1 to 8D will not be described again, and instead, only their differences will be mainly described.

The method illustrated in FIGS. 9A to 9C differs from the method illustrated in FIGS. 8A to 8D in that the resin composition RC is provided on the display module DM. Referring to FIG. 9A, the resin composition RC may be provided on a first surface DM_F1 of the display module DM. The resin composition RC may be directly provided on the first surface DM_F1 of the display module DM. In the display module DM, the first surface DM_F1 may be a top surface adjacent to the first display surface FS (see FIG. 1A).

As described above, the viscosity of the resin composition RC measured at 25° C. by the JIS K7117-2 method is about 5 mPa·s to about 20 mPa·s, and the resin composition RC including the polyether-modified dimethylsiloxane may be provided to cover the curvature of a step SP-b in the display module DM. The resin composition RC satisfying the above-described viscosity range and including the polyether-modified dimethylsiloxane may be applied so that there is no empty space in a curved portion such as the step SP-b. In addition, the resin composition RC may be uniformly (e.g., substantially uniformly) applied in a preset thickness without flowing out of a part, i.e., the display module DM, on which the resin composition RC is to be provided.

Referring to FIG. 9B, the first light UV-1 may be provided to the resin composition RC uniformly (e.g., substantially uniformly) applied. As the first light UV-1 is provided to the resin composition RC, the preliminary adhesive member P-AP (see FIG. 9C) may be formed. Referring to FIG. 9C, the window WP may be provided on the preliminary adhesive member P-AP. The second light UV-2 may pass through the window WP to be provided to the preliminary adhesive member P-AP. The adhesive member AP (see FIGS. 3 and 5) may be formed by curing the preliminary adhesive member P-AP with the second light UV-2.

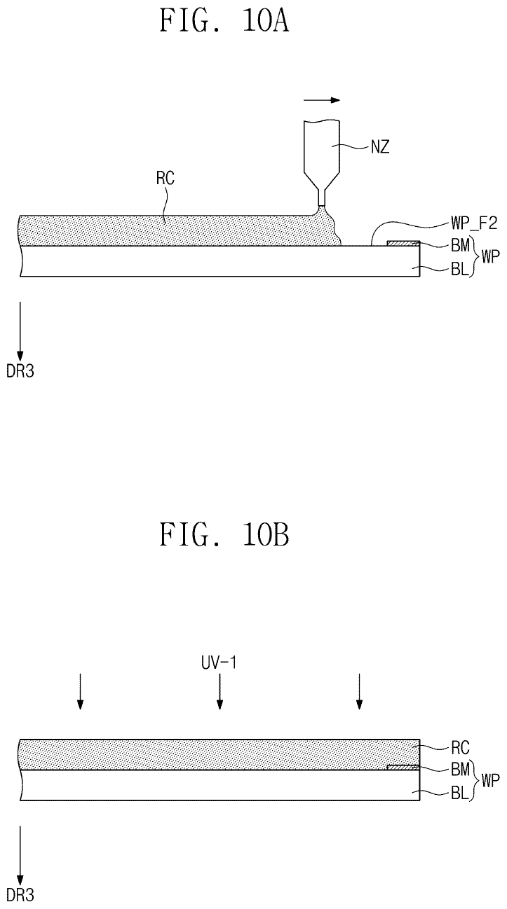

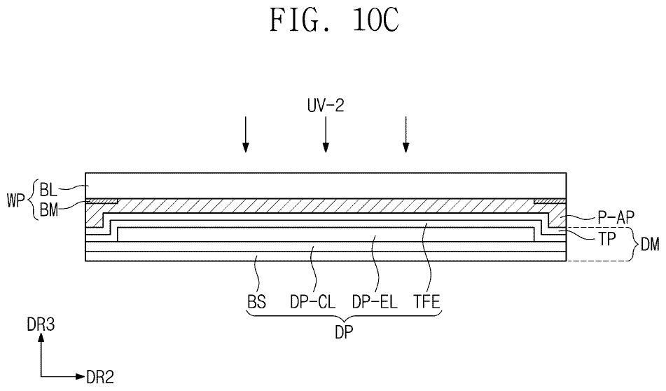

FIGS. 10A to 10C are each a view schematically illustrating a method for manufacturing a display device according to one or more embodiments of the present disclosure. Hereinafter, in the description of FIGS. 10A to 10C, the duplicated features which have been described with reference to FIGS. 1 to 9C will not be described again, and instead, only their differences will be mainly described.

The method illustrated in FIGS. 10A to 10C differs from the method illustrated in FIGS. 8A to 8D in that the resin composition RC is provided on the window WP. Referring to FIG. 10A, the resin composition RC may be provided on a second surface WP_F2 of the window WP. The resin composition RC may be directly provided on the second surface WP_F2 of the window WP. In the window WP, the second surface WP_F2 may be a bottom surface adjacent to the second display surface RS (see FIG. 1A).

Referring to FIG. 10B, the first light UV-1 may be provided to the resin composition RC uniformly (e.g., substantially uniformly) applied. As the first light UV-1 is provided to the resin composition RC, the preliminary adhesive member P-AP (see FIG. 10C) may be formed. Referring to FIG. 10C, the second light UV-2 may pass through the window WP to be provided to the preliminary adhesive member P-AP. The adhesive member AP (see FIGS. 3 and 5) may be formed by curing the preliminary adhesive member P-AP with the second light UV-2.

The method for manufacturing a display device of one or more embodiments may further include providing the light control layer PP (see FIGS. 5 and 6) and the optical adhesive layer AP-a. The providing of the light control layer PP (FIGS. 5 and 6) and the optical adhesive layer AP-a (FIGS. 5 and 6) may be performed between the step (e.g., act or task) of providing the adhesive member AP (FIGS. 5 and 6) and the step (e.g., act or task) of providing the window WP (FIGS. 5 and 6).

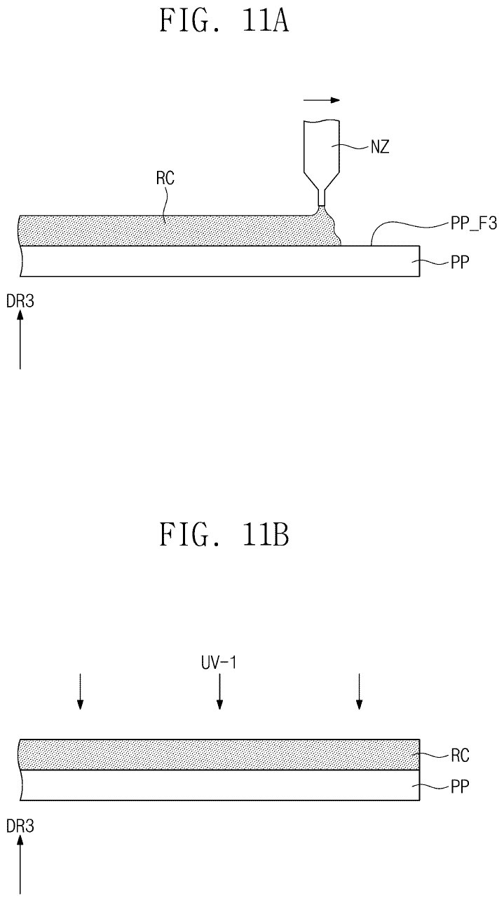

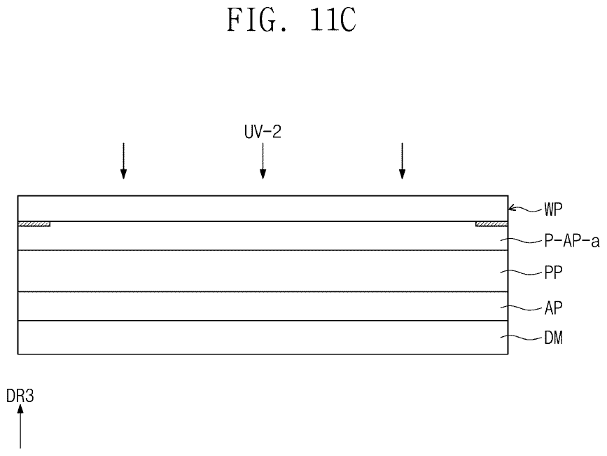

FIGS. 11A to 11C are each a view schematically illustrating a step (e.g., act or task) of providing the light control layer PP (see FIGS. 5 and 6) and the optical adhesive layer AP-a (see FIGS. 5 and 6). Hereinafter, in the description of FIGS. 11A to 11C, the duplicated features which have been described with reference to FIGS. 1 to 10C will not be described again, and instead, only their differences will be mainly described.

Referring to FIG. 11A, a light control layer PP may be prepared and provided, and the resin composition RC may be provided on the light control layer PP. The resin composition RC may be provided on a third surface PP_F3 of the light control layer PP. The resin composition RC may be directly provided on the third surface PP_F3 of the light control layer PP. In the light control layer PP, the third surface PP_F3 may be a top surface adjacent to the first display surface FS (see FIG. 1A). In one or more embodiments, in the light control layer PP, the third surface PP_F3 may be a lower surface adjacent to the second display surface RS (see FIG. 1A).

Referring to FIG. 11B, the first light UV-1 may be provided to the resin composition RC uniformly (e.g., substantially uniformly) applied. As the first light UV-1 is provided to the resin composition RC, a preliminary optical adhesive P-AP-a (see FIG. 11C) may be formed. Referring to FIG. 11C, the second light UV-2 may pass through the window WP to be provided to the preliminary optical adhesive P-AP-a. The adhesive member AP-a (see FIGS. 5 and 6) may be formed by curing the preliminary optical adhesive P-AP-a with the second light UV-2.

Hereinafter, with reference to Examples and Comparative Examples, a resin composition according to one or more embodiments of the present disclosure and an adhesive member formed from the resin composition will be described in more detail. In addition, Examples described herein are merely illustrations to assist the understanding of the disclosure, and the scope of the disclosure is not limited thereto.

### EXAMPLES

### 1. Synthesis of Polyether-modified Dimethylsiloxane

Hereinafter, the hydrosilylation reaction of a terminal vinyl-modified polyether and methyl hydrogen siloxane was performed by tracking the spectrum using Fourier-transform infrared spectroscopy (FT-IR, manufactured by Bruker corporation) and identifying and tracking the attenuation of the peak corresponding to the Si—H stretching vibration in the vicinity of 2150 cm⁻¹ in the spectrum.

Polyether-modified dimethylsiloxane was synthesized by a synthetic method described herein.

### Synthetic Method

Allyl-modified polyether was added in a round flask equipped with a three-one motor, stirring blades, and a glass tube connected to nitrogen gas, and then a Karstedt catalyst was added thereto to have a mass of platinum of about 100 ppm with respect to the mass of the total reactant, and stirred at about 500 rpm until uniformed at room temperature and under a nitrogen atmosphere. Then, the allyl-modified polyether was stirred at room temperature for 1 hour by adding methyl hydrogen siloxane to equalize the stoichiometric ratio of the hydrosilyl group of the methyl hydrogen siloxane. In addition, the reaction was further conducted by heating and stirring the reaction vessel at 60° C. in a constant temperature bath. The progress of the reaction was tracked by Fourier transform induced spectroscopy (FT-IR), and the time point at which the peak corresponding to the Si—H stretching vibration in the vicinity of 2150 cm⁻¹ was completely lost was taken as the reaction completion. After the completion of the reaction, the flask was taken out of the constant temperature bath and sufficiently cooled to obtain polyether-modified dimethylsiloxane.

### Synthesis of Polyether-modified Dimethylsiloxane ES-1

SANICOL H-0725 (produced by Sanyo Chemical Industries, number-average molecular weight: 1650) (33.0 g) was used as the allyl modified polyether, and poly(dimethylsiloxane), hydride terminated (produced by Sigma-Aldrich, product number: 423785, number-average molecular weight: 580), (5.80 g) was used as the methyl hydrogen siloxane to afford polyether-modified dimethylsiloxane ES-1 (number-average molecular weight: 3880) (38.8 g) by the above-described synthetic method. The molecular weight of the dimethylsiloxane group was about 15% based on 100% of the total molecular weight of the polyether-modified dimethylsiloxane ES-1.

### Synthesis of Polyether-modified Dimethylsiloxane ES-2

UNIOX PKA-5002 (produced by NOF CORPORATION (Japan Oil), number-average molecular weight: 400) (24.0 g) was used as the allyl modified polyether, and poly(dimethylsiloxane), hydride terminated (produced by Sigma-Aldrich, product number: 482145, number-average molecular weight: 580), (17.4 g) was used as the methyl hydrogen siloxane to afford polyether-modified dimethylsiloxane ES-2 (number-average molecular weight: 1380) (41.4 g) by the above-described synthetic method. The molecular weight of the dimethylsiloxane group was about 42% based on 100% of the total molecular weight of the polyether-modified dimethylsiloxane ES-2.

### Synthesis of Polyether-modified Dimethylsiloxane ES-3

UNIOX PKA-5005 (produced by NOF CORPORATION (Japan Oil), number-average molecular weight: 1,500) (6.0 g) was used as the allyl modified polyether, and poly(dimethylsiloxane), hydride terminated (produced by Sigma-Aldrich, product number: 482145, number-average molecular weight: 24,000), (52.0 g) was used as the methyl hydrogen siloxane to afford polyether-modified dimethylsiloxane ES-3 (number-average molecular weight: 27,000) (58.0 g) by the above-described synthetic method. The molecular weight of the dimethylsiloxane group was about 90% based on 100% of the total molecular weight of the polyether-modified dimethylsiloxane ES-3.

### Synthesis of Polyether-modified Dimethylsiloxane ES-4

SANICOL H-0725 (produced by Sanyo Chemical Industries, number-average molecular weight: 1,650) (33.0 g) was used as the allyl modified polyether, and 1,1,3,3,5,5,7,7,9,9,11,11,13,13-tetradecamethylheptasiloxane (produced by Tokyo Chemical Industry (Tokyo Kasei), number-average molecular weight: 505) (5.05 g) was used as the methyl hydrogen siloxane to afford polyether-modified dimethylsiloxane ES-4 (number-average molecular weight: 3,805) (38.1 g) by the above-described synthetic method. The molecular weight of the dimethylsiloxane group was about 13% based on 100% of the total molecular weight of the polyether-modified dimethylsiloxane ES-4.

The synthesized polyether-modified dimethylsiloxanes ES-1 to ES-3 are the polyether-modified dimethylsiloxane according to one or more embodiments of the present disclosure. The polyether-modified dimethylsiloxanes ES-1 to ES-3 have a number-average molecular weight of about 1,000 to about 30,000. For the polyether-modified dimethylsiloxanes ES-1 to ES-3, the molecular weight of the dimethylsiloxane group is about 15% to about 90% based on 100% of the total molecular weight of the polyether-modified dimethylsiloxane. That is, the polyether-modified dimethylsiloxanes ES-1 to ES-3 satisfy the number-average molecular weight range and the molecular weight range of the dimethylsiloxane group according to one or more embodiments.

In addition, the synthesized polyether-modified dimethylsiloxane ES-4 is the polyether-modified dimethylsiloxane of Comparative Example. For the polyether-modified dimethylsiloxane ES-4, the molecular weight of the dimethylsiloxane group is about 13% based on 100% of the total molecular weight of the polyether-modified dimethylsiloxane, which does not satisfy the molecular weight range of the dimethylsiloxane group according to one or more embodiments.

### 2. Manufacture and Evaluation of Resin Composition or Adhesive Member

The materials listed in Tables 1 and 2 were provided to a light-shielding sealed container according to a blending ratio (unit: parts by weight), and stirred at room temperature for 12 hours using a mix rotor. When the blend was identified substantially uniform, it was used as the resin composition of Examples, Comparative Examples, or Reference Examples.

For each of the resin compositions, uniformity, viscosity, inkjet ejection stability, and wettability/spreadability were evaluated and the results are shown in Tables 1 and 2. The evaluation of wettability/spreadability is obtained by measuring the diameter of the droplet over time, and related to Expression 1 as described above.

### Uniformity of Resin Composition/Adhesive Member

The uniformity of the resin composition and the adhesive member formed by photocuring the resin composition was visually confirmed and recorded as “O” or “X.” During the photocuring, light was emitted using a 365-nm UV-LED lamp so that the total amount of light was about 500 mJ/cm². In the uniformity of Tables 1 and 2, “O” refers to that the resin composition and the adhesive member are substantially uniform without insolubility, suspension, and white turbidity. “X” refers to that insolubility, suspension, and/or white turbidity occurs in the resin composition and the adhesive member.

### Viscosity of Resin Composition

In Tables 1 and 2, the viscosity of the resin composition was measured at about 25° C. by the JIS K7117-2 method. The viscosity was measured using a viscometer TVE-25L (manufactured by TOKI SANGYO Co., Ltd.) at a speed of about rpm.

### Inkjet Ejection Stability of Resin Composition

The resin composition was subjected to a discharge test using an inkjet device equipped with an inkjet head, KM1024i (manufactured by Konica Minolta Inc.), and inkjet ejection properties were recorded as “O” or “X”. In the inkjet ejection stability of Tables 1 and 2, “O” refers to that non-ejection due to nozzle clogging, a change in droplet size, a change in ejection speed, and a curve in the ejection direction do not occur substantially. “X” refers to that at least one of non-ejection due to nozzle clogging, a change in droplet size, a change in ejection speed, or a curve in the ejection direction has occurred.

### Wettability/Spreadability of Resin Composition

According to the JIS R3257 method, the contact angle meter DMo-601 (manufactured by Kyowa interface science Co. Ltd.) was used to deposit a resin composition on a member (soda-lime glass, a polarization plate, or PET), and a first diameter of the droplet 1 second after the deposition and a second diameter of the droplet 60 seconds after the deposition were each measured over time through an upper surface observation. From the first diameter and the second diameter, D_{L} (ratio of the second diameter to the first diameter) was calculated by Expression 1 as described above and the results are recorded in Table 1.

FIG. 12A is a view schematically illustrating a droplet formed by providing the resin composition of Example on a member ST according to the JIS R3257 method, and schematically illustrates a droplet when D_{L} is about 1.0 to about 1.2. FIG. 12B is a view schematically illustrating a droplet formed by providing the resin composition of Comparative Example on the member ST, and schematically illustrates a droplet when D_{L} is greater than about 1.2. In FIGS. 12A and 12B, L-A is a droplet having the first diameter, and L-BE and L-BC are each a droplet having the second diameter.

Referring to FIG. 12A, it may be seen that a size difference between the droplet L-A and the droplet L-BE is relatively small. For example, it may be seen that the first diameter of the droplet 1 second after the deposition and the second diameter of the droplet 60 seconds after the deposition exhibit similar levels. In contrast, referring to FIG. 12B, it may be seen that a size difference between the droplet L-A and the droplet L-BC is relatively large. For example, it may be seen that the first diameter of the droplet 1 second after the deposition and the second diameter of the droplet 60 seconds after the deposition exhibit a very large difference.

Data about Materials in Tables 1 and 2

UF-C051: Urethane acrylate oligomer (weight-average molecular weight: 35,000 (catalog data), produced by Kyoeisha Chemical Co., Ltd.)

UN6304: Urethane acrylate oligomer (weight-average molecular weight 13,000 (catalog data), produced by Negami Chemical Industrial Co. Ltd.)

### Monofunctional (Meth)Acrylate Monomer

4-HBA: 4-Hydroxybutyl acrylate (produced by Osaka Organic Chemical Industry, Ltd.)

2-EHA: 2-Ethylhexyl acrylate (produced by Toagosei Co., Ltd.)

### Photoinitiator

Omnirad 819: Phenylbis(2,4,6-trimethylbenzoyl)phosphine oxide (produced by IGM Resins)

### Dimethylsiloxane

DMS-T22: Polydimethylsiloxane (produced by Gelest Inc.)

TABLE 1

| Type | Name | Example 1 | Example 2 | Example 3 | Example 4 | Example 5 | Example 6 |
|---|---|---|---|---|---|---|---|
| Urethane | UF-C051 | 5 | 5 | 5 | 5 | 5 | 5 |
| (meth)acrylate | UN6304 | 5 | 5 | 5 | 5 | 5 | 5 |
| Monofunctional | 4-HBA | 5 | 5 | 5 | 5 | 5 | 5 |
| (meth)acrylate | 2-EHA | 85 | 85 | 85 | 85 | 85 | 85 |
| monomer | | | | | | | |
| Photoinitiator | Omnirad | 3 | 3 | 3 | 3 | 3 | 3 |
| | 819 | | | | | | |
| Polyether-modified | ES-1 | 0.001 | 0.1 | | | | |
| dimethylsiloxane | ES-2 | | | 0.001 | 0.1 | | |
| | ES-3 | | | | | 0.001 | 0.1 |
| Uniformity | | ◯ | ◯ | ◯ | ◯ | ◯ | ◯ |
| Viscosity [mPa · s, 25° C.] | | 14.4 | 14 | 14 | 14 | 15 | 14 |
| Inkjet ejection stability | | ◯ | ◯ | ◯ | ◯ | ◯ | ◯ |
| Wettability/ | Soda-lime | 1.1 | 1.1 | 1.1 | 1.1 | 1.0 | 1.0 |
| spreadability | glass | | | | | | |
| (D_{L}) | Polarization | 1.2 | 1.1 | 1.2 | 1.1 | 1.0 | 1.0 |
| | plate | | | | | | |
| | PET | 1.2 | 1.2 | 1.2 | 1.1 | 1.0 | 1.1 |

Referring to Table 1, it may be confirmed that each of the resin compositions of Examples 1 to 6 exhibits excellent or suitable inkjet ejection stability and has a viscosity of about 5 mPa·s to about 20 mPa·s as measured at about 25° C. by the JIS K7117-2 method, and excellent or suitable uniformity before and after the curing. As the uniformity of the resin composition is excellent or suitable, it may be seen that the resin compositions of Examples 1 to 6 each are optically clear after the curing. In addition, it may be confirmed that the resin compositions of Examples 1 to 6 each satisfy Expression 1 as described above with D_{L} of about 1.0 to about 1.2 for glass, a polarization plate, and PET. It may be seen that each of the resin compositions of Examples 1 to 6 may provide a droplet with a shape similar to that of FIG. 12A, having similar levels between the first diameter 1 second after the deposition and the second diameter 60 seconds after the deposition. The dimethylsiloxane group segregates to the outermost surface of the droplet, exhibiting a pinning effect that fixes the droplet to the member (glass, polarization plate, or PET), while the polyether group exhibits good or suitable compatibility with the resin composition. This combination ensures the inkjet ejection stability and member applicability. Accordingly, it may be seen that the resin compositions of Examples 1 to 6 may each be precisely applied to one or more suitable members (e.g., components) constituting the display device.

The resin compositions of Examples 1 to 6 each include a urethane (meth)acrylate having a weight-average molecular weight of about 5,000 to about 50,000, a monofunctional (meth)acrylate monomer, a radical polymerization initiator, and a polyether-modified dimethylsiloxane having a number-average molecular weight of about 1,000 to about 30,000. The resin compositions of Examples 1 to 6 do not include a (any) polyfunctional (meth)acrylate monomer.

The polyether-modified dimethylsiloxanes ES-1 to ES-3 included in the corresponding resin compositions of Examples 1 to 6 satisfy the molecular weight range (i.e., about 15% to about 90%) of the dimethylsiloxane group according to one or more embodiments. In the resin compositions of Examples 1 to 6, the polyether-modified dimethylsiloxanes ES-1 to ES-3 are respectively provided in an amount of about 0.001 parts by weight to about 0.1 parts by weight based on 100 parts by weight of the sum of the weight of urethane (meth)acrylate and the weight of monofunctional (meth)acrylate. Accordingly, in one or more embodiments, it may be seen that a resin composition, which includes a urethane (meth)acrylate having a weight-average molecular weight of about 5,000 to about 50,000, a monofunctional (meth)acrylate monomer, a radical polymerization initiator, and a polyether-modified dimethylsiloxane having a number-average molecular weight of about 1,000 to about 30,000, satisfies a molecular weight range (about 15% to about 90%) of a dimethylsiloxane group and a weight range (about 0.001 parts by weight to about 0.1 parts by weight) of the polyether-modified dimethylsiloxane, and has a viscosity as measured at about 25° by the JIS K7117-2 method of about 5 mPa·s to about 20 mPa·s, shows characteristics in that the resin composition can be precisely applied to one or more suitable members constituting the display device.

TABLE 2

| | | Comparative | Comparative | Comparative | Comparative | Comparative | Comparative | Reference |
|---|---|---|---|---|---|---|---|---|
| Type | Name | Example 1 | Example 2 | Example 3 | Example 4 | Example 5 | Example 6 | Example |
| Urethane | UF-C051 | 5 | 5 | 5 | 5 | 5 | 5 | 5 |
| (meth)acrylate | UN6304 | 5 | 5 | 5 | 5 | 5 | 5 | 5 |
| Monofunctional | 4-HBA | 5 | 5 | 5 | 5 | 5 | 5 | 5 |
| (meth)acrylate | 2-EHA | 85 | 85 | 85 | 85 | 85 | 85 | 85 |
| monomer | | | | | | | | |
| Photoinitiator | Omnirad | 3 | 3 | 3 | 3 | 3 | 3 | 3 |
| | 819 | | | | | | | |
| Polyether- | ES-1 | | | 1.0 | | | | |
| modified | ES-2 | | | | 1.0 | | | |
| dimethylsiloxane | ES-3 | | 0.0001 | | | 1.0 | | |
| | ES-4 | | | | | | 0.1 | |
| Dimethylsiloxane | DMS-T22 | | | | | | | 0.01 |
| Uniformity | | ◯ | ◯ | ◯ | ◯ | X | ◯ | X |
| Viscosity [mPa · s, 25° C.] | | 14 | 14 | 14 | 14 | — | 14 | — |
| Inkjet ejection stability | | ◯ | ◯ | X | X | — | ◯ | — |
| Wettability/ | Soda-lime | 1.8 | 1.7 | 1.0 | 1.0 | — | 1.5 | — |
| spreadability | glass | | | | | | | |
| (D_{L}) | Polarization | 1.9 | 1.8 | 1.0 | 1.0 | — | 1.6 | — |
| | plate | | | | | | | |
| | PET | 2.1 | 2.0 | 1.1 | 1.1 | — | 1.9 | — |

Referring to Table 2, the resin composition of Comparative Example 1 does not include polyether-modified dimethylsiloxane. It was confirmed that the resin composition of Comparative Example 1 had good or suitable inkjet ejection stability, but showed large wettability/spreadability of droplets after the deposition, thereby flowing out of a desired application range and exhibiting unstable applicability. The resin composition of Comparative Example 1 exhibited a D_{L} of greater than about 1.2, and has very high wettability/spreadability after the deposition.

The resin composition of Comparative Example 1 includes a large amount of monomers exhibiting low surface tension with low viscosity while not including a polyether-modified dimethylsiloxane, and thus has very high fluidity, and exhibits relatively large wettability/spreadability on the glass and the polarization plate after the deposition. In addition, because the resin composition of Comparative Example 1 includes a monomer exhibiting volatility at room temperature while not including polyether-modified dimethylsiloxane, a coffee ring phenomenon is exhibited due to the non-uniform drying in the entire surface of the composition, and thus the thicknesses of droplets are also likely to be non-uniform. It may be seen that the resin composition of Comparative Example 1 provides a droplet with a shape similar to that of FIG. 12B after the deposition.

The resin compositions of Comparative Examples 2 to 5 are each provided in an amount of either less than about 0.001 parts by weight or more than about 0.1 parts by weight of polyether-modified dimethylsiloxane based on 100 parts by weight of the sum of the weight of urethane (meth)acrylate and the weight of monofunctional (meth)acrylate. For example, for the resin compositions of Comparative Examples 2 and 3, the weight range of the polyether-modified dimethylsiloxane does not satisfy the range according to one or more embodiments (about 0.001 parts by weight to about 0.1 parts by weight).

The resin composition of Comparative Example 2 is provided with a small amount of polyether-modified dimethylsiloxane, so that the pinning effect is not exhibited and the D_{L} is greater than about 1.2. It may be seen that the resin composition of Comparative Example 2 provides a droplet with a shape similar to that of FIG. 12B after the deposition.

The resin compositions of Comparative Examples 3 and 4 each were not stably ejected due to a problem in inkjet ejection by excessively providing polyether-modified dimethylsiloxane. The resin composition of Comparative Example 5 exhibits non-uniform characteristics because the polyether-modified dimethylsiloxane ES-3 is not dissolved like other materials (i.e., urethane (meth)acrylate, a monofunctional (meth)acrylate monomer, a photoinitiator). Accordingly, the resin composition of Comparative Example 5 was not subjected to the evaluation of viscosity, inkjet ejection stability, and wettability/spreadability.

The resin composition of Comparative Example 6 includes polyether-modified dimethylsiloxane ES-4, and as described above, the polyether-modified dimethylsiloxane ES-4 has a molecular weight of about 13% of the dimethylsiloxane group and does not satisfy the molecular weight range (about 15% to about 90%) of the dimethylsiloxane group according to one or more embodiments. The resin composition of Comparative Example 6 includes a relatively small molecular weight of dimethylsiloxane group, so that the pinning effect is not exhibited and the D_{L} is greater than about 1.2. It may be seen that the resin composition of Comparative Example 6 provides a droplet with a shape similar to that of FIG. 12B after the deposition.

The resin composition of Reference Example does not include polyether-modified dimethylsiloxane. It may be seen that the resin composition of Reference Example includes dimethylsiloxane not including a polyether group and exhibits non-uniform characteristics. Accordingly, the resin composition of Reference Example was not subjected to the evaluation of viscosity, inkjet ejection stability, and wettability/spreadability.

The display device of one or more embodiments may include the adhesive member arranged between the display panel and the window. The adhesive member may include a polymer derived from the resin composition of one or more embodiments. The display device of one or more embodiments may be manufactured by a method for manufacturing a display device of one or more embodiments. The method for manufacturing a display device of one or more embodiments may include forming an adhesive member from the resin composition of one or more embodiments.

The resin composition of one or more embodiments includes at least one urethane (meth)acrylate having a weight-average molecular weight of about 5,000 to about 50,000, at least one monofunctional (meth)acrylate monomer, at least one photoinitiator including a radical polymerization initiator, and a polyether-modified dimethylsiloxane including a polyether group and a dimethylsiloxane group and having a number-average molecular weight of about 1,000 to about 30,000, and may not include a (e.g., may exclude any) polyfunctional (meth)acrylate monomer. The resin composition of one or more embodiments may have a viscosity of about 5 mPa·s to about 20 mPa·s as measured at about 25° C. by the JIS K7117-2 method. In the resin composition of one or more embodiments, based on 100% of the total molecular weight of the polyether-modified dimethylsiloxane, the molecular weight of the dimethylsiloxane group is about 15% to about 90%, and if (e.g., when) the sum of the weight of the urethane (meth)acrylate and the weight of the monofunctional (meth)acrylate monomer is 100 parts by weight, the weight of the polyether-modified dimethylsiloxane may be about 0.001 parts by weight to about 0.1 parts by weight. Accordingly, the resin composition of one or more embodiments may exhibit the characteristics such that the resin composition may be precisely applied to one or more suitable members constituting the display device.

The resin composition according to one or more embodiments of the disclosure may exhibit excellent or suitable applicability on one or more suitable members by including a polyether-modified dimethylsiloxane.

The method for manufacturing a display device according to one or more embodiments of the disclosure may exhibit excellent or suitable manufacture efficiency by including providing the resin composition of one or more embodiments to form an adhesive member.

The display device according to one or more embodiments of the disclosure may exhibit excellent or suitable display quality by including the adhesive member formed from the resin composition of one or more embodiments.

In other words, the display device, as described in various embodiments, includes an adhesive member positioned between the display panel and the window. This adhesive member is derived from a specific resin composition that includes urethane (meth)acrylate(s) with a weight-average molecular weight of about 5,000 to about 50,000, monofunctional (meth)acrylate monomer(s), a photoinitiator, and polyether-modified dimethylsiloxane with a number-average molecular weight of about 1,000 to about 30,000, but excludes any polyfunctional (meth)acrylate monomer. The resin composition has a viscosity of about 5 mPa·s to about 20 mPa·s at about 25° C. and ensures excellent inkjet ejection stability and uniformity. The method for manufacturing the display device involves forming the adhesive member from this resin composition, which provides excellent applicability and manufacturing efficiency. Consequently, the display device exhibits high display quality due to the precise application of the adhesive member.

In the present disclosure, the weight average molecular weight or the number-averaged molecular weight of a polymer or an oligomer such as the urethane (meth)acrylate, the polyether-modified dimethylsiloxane, and/or the like may be measured by gel permeation chromatography (GPC). In the present disclosure, the term “dimethylsiloxane” may be interchangeable with the term “polydimethylsiloxane.”

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present application and unless otherwise defined, the terms “use,” “using,” and “used” may be considered synonymous with the terms “utilize,” “utilizing,” and “utilized,” respectively.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this disclosure, including the claims, to expressly recite any sub-range subsumed within the ranges expressly recited herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

The adhesive member-manufacturing apparatus, the light-emitting element, the electronic devices/apparatus, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the present disclosure has been described with reference to example embodiments of the disclosure, it will be understood that the present disclosure should not be limited to these embodiments but one or more suitable changes and modifications can be made by those skilled in the art without departing from the spirit and scope of the present disclosure.

Accordingly, the technical scope of the present disclosure is not intended to be limited to the contents set forth in the detailed description of the disclosure, but is intended to be defined by the appended claims and equivalents thereof.

What is claimed is:

1. A resin composition comprising:
at least one urethane (meth)acrylate having a weight-average molecular weight of about 5,000 to about 50,000;
at least one monofunctional (meth)acrylate monomer;
at least one photoinitiator comprising a radical polymerization initiator; and
a polyether-modified dimethylsiloxane having a number-average molecular weight of about 1,000 to about 30,000 and comprising a polyether group and a dimethylsiloxane group,
wherein,
the resin composition excludes any polyfunctional (meth)acrylate monomer,
a viscosity of the resin composition measured at about 25° C. by the JIS K7117-method is in a range of about 5 mPa·s to about 20 mPa·s,
a molecular weight of the dimethylsiloxane group is in a range of about 15% to about 90% based on 100% of a total molecular weight of the polyether-modified dimethylsiloxane, and
when the sum of a weight of the urethane (meth)acrylate and a weight of the monofunctional (meth)acrylate monomer is 100 parts by weight, then a weight of the polyether-modified dimethylsiloxane is in a range of about 0.001 parts by weight to about 0.1 parts by weight.

2. The resin composition of claim 1, wherein the resin composition satisfies Expression 1
$$1. \leq {D}_{L} \leq 1.2 , \qquad Expression 1$$
in Expression 1,
D_{L} being a ratio of a second diameter to a first diameter,
the first diameter being a diameter of a droplet measured 1 second after providing the resin composition on a member according to the JIS R 3257 method, and
the second diameter being a diameter of the droplet measured 60 seconds after providing the resin composition on the member.

3. The resin composition of claim 1, wherein the monofunctional (meth)acrylate monomer comprises at least one of 4-hydroxybutyl acrylate or 2-ethylhexyl acrylate.

4. The resin composition of claim 1, wherein the weight of the monofunctional (meth)acrylate monomer is about 87 wt % to about 93 wt % based on the sum 100 wt % of the weight of the urethane (meth)acrylate and the weight of the monofunctional (meth)acrylate monomer.

5. The resin composition of claim 1, wherein the radical polymerization initiator comprises phenylbis(2,4,6-trimethylbenzoyl)phosphine oxide.

6. The resin composition of claim 1, wherein the resin composition is provided by an inkjet printing method or a dispensing method.

7. A method, comprising:
preparing a display module;
providing a window on the display module; and
providing an adhesive member on a first surface of the display module or a second surface of the window before the providing of the window,
wherein the providing of the adhesive member comprises:
providing a resin composition on the first surface or the second surface, the resin composition having a viscosity of about 5 mPa·s to about 20 mPa·s as measured at about 25° C. by the JIS K7117-2 method; and
providing light to the resin composition to form the adhesive member, wherein the resin composition comprises:
at least one urethane (meth)acrylate having a weight-average molecular weight of about 5,000 to about 50,000;
at least one monofunctional (meth)acrylate monomer;
at least one photoinitiator comprising a radical polymerization initiator; and
a polyether-modified dimethylsiloxane having a number-average molecular weight of about 1,000 to about 30,000 and comprising a polyether group and a dimethylsiloxane group, and
excludes any polyfunctional (meth)acrylate monomer, and
wherein,
a molecular weight of the dimethylsiloxane group is about 15% to about 90% based on 100% of a total molecular weight of the polyether-modified dimethylsiloxane, and
when the sum of a weight of the urethane (meth)acrylate and a weight of the monofunctional (meth)acrylate monomer is 100 parts by weight, then a weight of the polyether-modified dimethylsiloxane is about 0.001 parts by weight to about 0.1 parts by weight.

8. The method of claim 7, wherein the resin composition satisfies Expression 1
$$1. \leq {D}_{L} \leq 1.2 , \qquad Expression 1$$
in Expression 1,
D_{L} being a ratio of a second diameter to a first diameter,
the first diameter being a diameter of a droplet measured 1 second after providing the resin composition on a member according to the JIS R 3257 method, and
the second diameter being a diameter of the droplet measured 60 seconds after providing the resin composition on the member.

9. The method of claim 7, wherein the monofunctional (meth)acrylate monomer comprises at least one of 4-hydroxybutyl acrylate or 2-ethylhexyl acrylate.

10. The method of claim 7, wherein the resin composition is provided by an inkjet printing method or a dispensing method.

11. The method of claim 7, wherein the resin composition is provided directly on the first surface or the second surface.

12. The method of claim 7, between the providing of the adhesive member and the providing of the window, further comprising:
preparing a light control layer; and
providing the resin composition on a third surface of the light control layer to form an optical adhesive layer.

13. The method of claim 12, wherein the resin composition is provided directly on the third surface.

14. An electronic device comprising:
a display panel;
a window on the display panel; and
an adhesive member between the display panel and the window and comprising a polymer derived from a resin composition, the resin composition having a viscosity of about 5 mPa·s to about 20 mPa·s as measured at about 25° C. by the JIS K7117-2 method,
wherein the resin composition comprises:
at least one urethane (meth)acrylate having a weight-average molecular weight of about 5,000 to about 50,000;
at least one monofunctional (meth)acrylate monomer;
at least one photoinitiator comprising a radical polymerization initiator; and
a polyether-modified dimethylsiloxane having a number-average molecular weight of about 1,000 to about 30,000 and comprising a polyether group and a dimethylsiloxane group, and
excludes any polyfunctional (meth)acrylate monomer, and
wherein,
a molecular weight of the dimethylsiloxane group is about 15% to about 90% based on 100% of a total molecular weight of the polyether-modified dimethylsiloxane, and
when the sum of a weight of the urethane (meth)acrylate and a weight of the monofunctional (meth)acrylate monomer is 100 parts by weight, a weight of the polyether-modified dimethylsiloxane is about 0.001 parts by weight to about 0.1 parts by weight.

15. The electronic device of claim 14, wherein the resin composition satisfies Expression 1
$$1. \leq {D}_{L} \leq 1.2 , \qquad Expression 1$$
in Expression 1,
D_{L} being a ratio of a second diameter to a first diameter,
the first diameter being a diameter of a droplet measured 1 second after providing the resin composition on a member according to the JIS R 3257 method, and
the second diameter being a diameter of the droplet measured 60 seconds after providing the resin composition on the member.

16. The electronic device of claim 14, wherein the monofunctional (meth)acrylate monomer comprises at least one of 4-hydroxybutyl acrylate or 2-ethylhexyl acrylate.

17. The electronic device of claim 14, wherein the adhesive member is optically clear.

18. The electronic device of claim 14, further comprising:
a light control layer between the adhesive member and the window; and
an optical adhesive layer between the light control layer and the window,
wherein the optical adhesive layer comprises the polymer derived from the resin composition.

19. The electronic device of claim 18, wherein the light control layer comprises a polarization plate or a color filter layer.

20. The electronic device of claim 14, wherein the display panel is foldable with respect to at least one folding axis.

21. The electronic device of claim 14, further comprising an input sensing unit between the display panel and the window,
wherein the adhesive member is between the display panel and the input sensing unit or between the input sensing unit and the window.
